(19) United States
(12) Patent Application Publication
(10) Pub. No.: US 2025/0145756 A1
(43) Pub. Date: May 8, 2025

(54) RE-DISPERSIBLE OR RE-SOLUBLE AQUEOUS ETHYLENICALLY UNSATURATED AQUEOUS POLYURETHANE COMPOSITIONS WITH IMPROVED WATER-RESISTANCE

(71) Applicant: BASF SE, Ludwigshafen Am Rhein (DE)

(72) Inventors: Christine ROESCH, Ludwigshafen am Rhein (DE); Susanne NEUMANN, Ludwigshafen am Rhein (DE); Peter THUERY, Ludwigshafen am Rhein (DE); Vanessa KLEE, Ludwigshafen am Rhein (DE); Tunja JUNG, Ludwighshafen am Rhein (DE); Sarah HAHN, Ludwighshafen am Rhein (DE)

(21) Appl. No.: 18/838,312

(22) PCT Filed: Mar. 15, 2023
(86) PCT No.: PCT/EP2023/056563

§ 371 Date: Aug. 14, 2024

(30) Foreign Application Priority Data
Mar. 18, 2022 (EP) 22163093.2

(51) Int. Cl. C08G 18/08; C08G 18/18; C08G 18/34; C08G 18/38; C08G 18/81; C09D 5/00; C09D 5/02; C09D 175/16

(52) U.S. Cl. CPC C08G 18/0828; C08G 18/0866; C08G 18/1825; C08G 18/348; C08G 18/3857; C08G 18/8175; C09D 5/002; C09D 5/028; C09D 175/16

(57) ABSTRACT

Disclosed herein is a composition including
(i) at least one polyurethane (1) carrying ethylenically unsaturated groups and COOH groups, which COOH groups are at least partly in the form of a salt group thereof, which polyurethane is obtained by the reaction of
at least one polyol (B1) carrying at least one COOH group,
at least monoalcohol (B2) carrying at least one ethylenically unsaturated group,
optionally at least polyol (B3) carrying at least one ethylenically unsaturated group and no COOH group,
at least one polyol (B4) carrying no ethylenically unsaturated group and no COOH group,
at least one polyisocyanate (A1) carrying at least one ethylenically unsaturated group,
optionally at least one polyisocyanate (A2) carrying no ethylenically unsaturated group, and
optionally at least one compound (C1) carrying at least one NH2 group and no OH group.

Further disclosed herein are an aqueous coating composition including the composition, a layer formed from the aqueous coating composition, and a substrate coated with the layer.

The present invention relates to aqueous ethylenically unsaturated polyurethane compositions, to aqueous coating compositions comprising these compositions, to layers formed from the coating compositions, and to substrates coated with the layers.

Aqueous polyurethane compositions are used as binder in many applications, for example in coating compositions such as primer compositions and wood stain compositions, in ink compositions and in adhesive compositions.

It is desired that dried residues formed from the compositions on machines and equipment used to apply the compositions on a substrate are re-dispersible or re-soluble in water. This allows the removal of the dried residues by simply treating machines and equipment with water, or even with the aqueous composition itself, which can lead to less or shorter interruptions in the process of applying the composition to a substrate.

When the compositions form dried residues that are re-dispersible or re-soluble in water, the compositions usually form dried layers, which do not show a good water-resistance. Thus, if a good water-resistance of the final layer is desired, compositions comprising polyurethanes carrying at least one ethylenically unsaturated group are usually preferred, as the layers formed from these compositions on a substrate can be crosslinked (or cured) in a second step.

Aqueous ethylenically unsaturated polyurethane compositions, which form dried layers that are re-dispersible or re-soluble in water, are known in the art.

WO2014111349 describes aqueous resin compositions comprising at least one polymerizable ethylenically unsaturated polyurethane polymer (A), wherein the polyurethane has a weight average molecular weight of less than 15000 g/mol, and is obtained from the reaction of at least one polyisocyanate (i), at least one hydrophilic compound (ii) containing at least one group capable of reacting with isocyanate groups and at least one group which is capable of rendering the polyurethane polymer dispersible or soluble in aqueous medium either directly or after neutralization with a neutralizing agent (C) to provide a salt, at least one compound (iii) containing at least one group capable of reacting with isocyanate groups and at least one copolymerizable unsaturated group, at least one compound (iv) containing at least two groups capable of reacting with isocyanate groups, and optionally at least one chain extender (v) congaing at least two groups capable of reacting with isocyanate groups, which chain extender is different from (iv), and wherein the non-volatile components of the resin composition (I) after drying are re-dispersible or re-soluble in water at 25° C. Example 1 of WO2014111349 describes an aqueous ethylenically unsaturated polyurethane composition prepared from hexamethylene diisocyanate, 2,2-dimethylol propionic acid, propoxylated trimethylolpropane diacrylate with an average of 3 propylene oxide units and EB113 (monofunctional epoxy acrylate).

Aqueous ethylenically unsaturated polyurethane composition, wherein the polyurethane comprises units derived from at least one polyisocyanate carrying at least one ethylenically unsaturated group, are also known in the art.

WO2006089935 describes aqueous ethylenically unsaturated polyurethane compositions, wherein the polyurethane comprises units derived from a polyisocyanate carrying at least one ethylenically unsaturated group. WO2006089935 shows that these compositions form cross-linked layers of high hardness but is silent about the re-dispersibility or re-solubility in water of the dried layers formed from the compositions.

It was the object of the present invention to provide aqueous ethylenically unsaturated polyurethane compositions and coating compositions comprising these compositions, which coating compositions form dried layers, which are re-dispersible or re-soluble in water at ambient temperatures for a certain period, and which layers, after being cross-linked, show a high water-resistance.

This object is solved by the composition of claim 1, the coating composition of claim 14, and the layer of claim 15 and the substrate of claim 16.

The composition of the present invention is a composition comprising
(i) at least one polyurethane (1) carrying ethylenically unsaturated groups and COOH groups, which COOH groups are at least partly in the form of a salt group thereof, which polyurethane is obtainable by the reaction of
at least one polyol (1) carrying at least one COOH group,
at least one monoalcohol (B2) carrying at least one ethylenically unsaturated group, optionally at least one polyol (B3) carrying at least one ethylenically unsaturated group and no COOH group,
at least one polyol (B4) carrying no ethylenically unsaturated group and no COOH group,
at least one polyisocyanate (A1) carrying at least one ethylenically unsaturated group,
optionally at least one polyisocyanate (A2) carrying no ethylenically unsaturated group, and
optionally at least one compound (C1) carrying at least one NH₂ group and no OH group,
wherein the equivalent ratio of ethylenically unsaturated groups of polyisocyanate (A1)/ethylenically unsaturated groups of components (1), (B2), (B3), (A1) and (C1) is in the range of from 0.20/1.00 to 0.95/1.00, and
wherein the equivalent ratio of NCO groups of polyisocyanate (A1) and (A2)/OH groups of components (1), (B2), (B3) and (B4) is in the range of from 1.00/1.00 to 1.50/1.00,
(ii) water, and
(iii) optionally at least one compound (2) carrying at least one ethylenically unsaturated group and no COOH group.

The equivalent ratio of ethylenically unsaturated groups provided of polyisocyanate (A1)/ethylenically unsaturated groups of components (B1), (B2), (B3), (A1) and (C1) is preferably in the range of from 0.30/1.00 to 0.90/1.00, more preferably in the range of from 0.40/1.00 to 0.80/1.00 even more preferably in the range of from 0.50/1.00 to 0.70/1.00 and most preferably in the range from 0.55/1.00 to 0.65/1.00.

Polyols have an OH functionality of at least 1.5.

The OH functionality of a polyol is (hydroxyl number polyol [g KOH/g]×molecular weight polyol)/molecular weight KOH. If the the polyol is an oligomer or polymer, the number average molecular weight of the polyol is used, which can be determined using gel permeation chromatography calibrated to a polystyrene standard. The molecular weight of KOH is 56 g/mol. The hydroxyl number of a polyol can be determined according to DIN53240, 2016.

Polyols can be aliphatic, alicylic or aromatic polyols.

Aromatic polyols are polyols, wherein at least one OH functionality is directly attached to an aromatic ring. Alicyclic polyols comprise at least one alicyclic ring and each OH functionality is not directly attached to an aromatic ring. Aliphatic polyols do not comprise an alicyclic ring and each OH functionality is not directly attached to an aromatic ring. Preferred aliphatic and alicyclic polyols do not comprise aromatic rings.

Monoalcohols have an OH functionality of below 1.5.

The OH functionality of a monoalcohol is (hydroxyl number monoalcohol [g KOH/g]× molecular weight monoalcohol)/molecular weight KOH. If the the monoalcohol is an oligomer or polymer, the number average molecular weight of the monoalcohol is used, which can be determined using gel permeation chromatography calibrated to a polystyrene standard. The molecular weight of KOH is 56 g/mol. The hydroxyl number of a monoalcohol can be determined according to DIN53240, 2016.

Monoalcohols can be an aliphatic, alicyclic or aromatic monoalcohol.

Aromatic monoalcohols are monoalcohols, wherein then OH functionality is directly attached to an aromatic ring. Alicyclic monoalcahols comprise at least one alicyclic ring and each OH functionality is not directly attached to an aromatic ring. Aliphatic monoalcohols do not comprise an alicyclic ring and the OH functionality is not directly attached to an aromatic ring. Preferred aliphatic and alicyclic monoalcohols do not comprise aromatic rings.

An ethylenically unsaturated group can be any ethylenically unsaturated group that can polymerize by free radical mechanism upon heat, radiation treatment, usually UV radiation treatment, in the presence of a suitable initiator, or upon electron beam treatment. Examples of ethylenically unsaturated groups are acryloyl, methacryloyl, vinyl and allyl groups. Preferred ethylenically unsaturated groups are selected from the group of acryloyl and methacryloyl groups. More preferred ethylenically unsaturated groups are acryloyl groups.

Polyisocyanates comprise polyisocyanates carrying blocked NCO groups as well as polyisocyanates carrying free NCO groups. Polyisocyanates carrying blocked NCO groups, can be deblocked to the corresponding polyisocyanate carrying free NCO groups under specific conditions, for example at elevated temperatures, such as at temperatures above 110° C. The polyisocyanate carrying blocked NCO groups is characterized in the following via its corresponding polyisocyanate carrying free NCO groups. Preferably, polyisocyanates comprise only polyisocyanates carrying free NCO groups.

Polyisocyanates have an NCO functionality of at least 1.5.

The NCO functionality of a polyisocyanate is NCO content× (molecular weight polyisocyanate/molecular weight NCO). If the polyisocyanate is a polymeric polyisocyanate, the average weight molecular weight of the polyisocyanate is used. The average weight molecular weight of a polymeric polyisocyanate can be determined using gel permeation chromatography calibrated to a polystyrene standard. The NCO content of the polyisocyanate is weight NCO/weight polyisocyanate. The molecular weight of NCO is 42 g/mol.

The NCO content of a polyisocyanate can be determined as follows:

10 mL of a 1 N solution of n-dibutyl amine in xylene is added to 1 g of a polisocyanate dissolved in 100 mL of N-methylpyrrolidone. The resulting mixture is stirred at room temperature for five minutes. Then, the resulting reaction mixture is subjected to back titration using 1 N hydrochloric acid to measure the volume of the hydrochloric acid needed for neutralizing the unreacted n-dibutyl amine. This then reveals how much mol n-dibutyl amine reacted with NCO groups. The NCO content is (“mol reacted n-dibutyl amine”× molecular weight NCO)/weight polyisocyanate. The weight of polyisocyanate is 1 g.

Polyisocyanate can be aliphatic, alicyclic or aromatic polyisocyanates.

Aromatic polyisocyanates are polyisocyanates, wherein at least one NCO functionality is directly attached to an aromatic ring. Alicyclic polyisocyanates comprise at least one alicyclic ring and each NCO functionality is not directly attached to an aromatic ring. Aliphatic polyisocyanates do not comprise an alicyclic ring and each NCO functionality is not directly attached to an aromatic ring. Preferred aliphatic and alicyclic polyisocyanates do not comprise aromatic rings.

Polyisocyanates can be monomeric polyisocyanates or polymeric polyisocyanate.

Examples of monomeric aliphatic polyisocyanates carrying no ethylenically unsaturated groups are tetramethylene 1,4-diisocyanate, pentamethylene 1,5-diisocyanate, hexamethylene 1,6-diisocyanate, heptamethylene 1,7-diisocyanate, octamethylene 1,8-diisocyanate, decamethylene 1,10-diisocyanate, dodecamethylene 1,12-diisocyanate, tetradecamethylene 1,14-diisocyanate, methyl 2,6-diisocyanatohexanoate, ethyl 2,6-diisocyanatohexanoate, 2,2,4-trimethylhexane 1,6-diisocyanate and 2,4,4-trimethylhexane 1,6-diisocyanate.

Further examples of monomeric aliphatic polyisocyanates carrying no ethylenically unsaturated groups are 1,4,8-triisocyanatononane and 2′-isocyanatoethyl 2,6-diisocyanatohexanoate.

Examples of monomeric alicyclic polyisocyanates carrying no ethylenically unsaturated groups are 1,4-diisocyanatocyclohexane, 1,3-diisocyanatocyclohexane, 1,2-diisocyanatocyclohexane, 4,4′-di(isocyanatocyclohexyl)methane, 2,4′-di(isocyanatocyclohexyl)methane, 1-isocyanato-3,3,5-trimethyl-5-(isocyanatomethyl)cyclohexane (isophorone diisocyanate), 1,3-bis(isocyanatomethyl)cyclohexane, 1,4-bis(isocyanatomethyl)cyclohexane, 2,4-diisocyanato-1-methylcyclohexane, 2,6-diisocyanato-1-methylcyclohexane and 3(or 4),8(or 9)-bis (isocyanatomethyl)tricyclo[5.2.1.0(2,6)]decane.

Examples of monomeric aromatic polyisocyanates carrying no ethylenically unsaturated groups are 2,4-tolylene diisocyanate, 2,6-tolylene diisocyanate, m-xylylene diisocyanate, p-xylylene diisocyanate, 2,4′-diisocyanatodiphenylmethane, 4,4′-diisocyanatodiphenylmethane, 1,3-phenylene diisocyanate, 1,4-phenylene diisocyanate, 1-chloro-2,4-phenylene diisocyanate, 1,5-naphthylene diisocyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene and diphenyl ether 4,4′-diisocyanate.

Further examples of monomeric aromatic polyisocyanates carrying no ethylenically unsaturated groups are 2,4,6-triisocyanatotoluene, triphenylmethane triisocyanate and 2,4,4′-triisocyanatodiphenyl ether.

Monomeric polyisocyanates carrying no ethylenically unsaturated group can be prepared by methods known in the art, for example by treating the corresponding amines with phosgene.

Polymeric polyisocyanate comprises at least two units derived from monomeric polyisocyanates. Polymeric polyisocyanates usually also comprise at least one structural unit selected from the group consisting of uretdione, isocyanurate, biuret, urea, carbodiimide, uretonimine, urethane, allophanate, oxadiazinetrione and iminooxadiazinedione.

The polyol (1) carrying at least one COOH group can be any aliphatic, alicyclic or aromatic polyol (1) carrying at least one COOH group.

The OH functionality of polyol (1) carrying at least one COOH group is usually in the range of from 1.7 to 6.0, more preferably in the range of 1.8 to 5.4, even more preferably in the range of 1.8 to 3.4, most preferably in the range from 1.8 to 2.4, and in particular in the range of 1.9 to 2.2.

The polyol (1) carrying at least one COOH group preferably has a number average molecular weight of below 750 g/mol, more preferably of below 500 g/mol, and most preferably of below 250 g/mol.

Examples of polyols (1) carrying one COOH group are 2,2-bis(hydroxymethyl) C₂₋₁₀-alkanoic acid such as 2,2-bis(hydroxymethyl) propionic acid (dimethylolpropionic acid), 2,2-bis(hydroxymethyl) butanoic acid and 2,2-bis(hydroxymethyl) pentanoic acid.

The polyol (1) carrying at least one COOH group is preferably a polyol carrying one COOH group, more preferably an aliphatic or alicyclic polyol (1) carrying one COOH group, even more preferably an aliphatic polyol (1) carrying one COOH group, most preferably selected from the group consisting of 2,2-bis(hydroxymethyl) propionic acid and 2,2-bis(hydroxymethyl) butanoic acid, and in particular 2,2-bis(hydroxymethyl) propionic acid.

The monoalcohol (E2) carrying at least one ethylenically unsaturated group can be any aliphatic, alicyclic or aromatic monoalcohol carrying at least one ethylenically unsaturated group.

The monoalcohol (E2) has preferably an OH functionality in the range of from 0.8 to 1.4, preferably in the range of 0.9 to 1.2.

Examples of monoalcohol (E2) carrying at least one ethylenically unsaturated group, wherein the ethylenically unsaturated group is an acryloyl or methacryloyl group, are monoesters of diols with acrylic acid or methacrylic acid, diesters of triols with acrylic acid or methacrylic acid and triesters of tetraols with acrylic acid or methacrylic acid and pentaesters of hexaols with acrylic acid or methacrylic acid.

Examples of monoesters of diols with acrylic or methacrylic acid are monoesters of C₁₋₁₀-aliphatic diols, preferably of C₁₋₆-aliphatic diols, with acrylic or methacrylic acid.

Examples of monoesters of C₁₋₆-aliphatic diols with acrylic or methacrylic acid are 2-hydroxyethyl methacrylate, 2-hydroxyethyl acrylate, 2-hydroxypropyl methacrylate, 2-hydroxypropyl acrylate, 3-hydroxypropyl methacrylate, 3-hydroxypropyl acrylate, 4-hydroxybutyl methacrylate and 4-hydroxylbutyl acrylate.

Further examples of monoalcohols (B2) carrying at least one ethylenically unsaturated group are diesters of ethoxylated or propoxylated 1,1,1-trimethylolpropane with acrylic or methacrylic acid, triesters of pentaerythritol with acrylic or methacrylic acid, triesters of ethoxylated or propoxylated di(1,1,1-trimethylol)propane with acrylic or methacrylic acid and pentaesters of dipentaerythritol.

Examples of monoalcohols (B2) carrying at least one allyl group are 2-allyloxyethanol and 2,2-bis(allyloxymethyl)butan-1-ol.

The monoalcohol (B2) carrying at least one ethylenically unsaturated group is preferably a monoalcohol carrying at least one acryloyl or methacryloyl group, more preferably a monoalcohol carrying one acryloyl or methacryloyl group. Even more preferably the monoalcohol (B2) carrying at least one ethylenically unsaturated group is an aliphatic or alicyclic monoalcohol (B2) carrying one acryloyl or methacryloyl group, most preferably a monoester of a C₁₋₆-aliphatc diol with acrylic acid or methacrylic acid, and in particular 2-hydroxyethyl acrylate.

The polyol (B3) carrying at least one ethylenically unsaturated group and no COOH group can be any aliphatic, alicyclic or aromatic polyol (B3) carrying at least one ethylenically unsaturated group and no COOH group.

The OH functionality of polyol (B3) carrying at least one ethylenically unsaturated group and no COOH group is usually in the range of from 1.7 to 6.4, more preferably in the range of 1.8 to 5.4, even more preferably in the range of 1.8 to 3.4, most preferably in the range from 1.8 to 2.4, and in particular in the range of 1.9 to 2.2.

The polyol (B3) carrying at least one ethylenically unsaturated group and no COOH group can be a polyol carrying at least one acryloyl or methacryloyl group and no COOH group.

Examples of polyol (B3) carrying at least one acryloyl or methacryloyl group and no COOH group are monoesters of triols carrying no COOH group with acrylic acid or methacrylic acid, diesters of tetraols carrying no COOH group with acrylic acid or methacrylic acid and the diesters, triesters or tetraesters of hexaols carrying no COOH group with acrylic acid or methacrylic acid.

Further examples of polyols (B3) carrying at least one acryloyl or methacryloyl group and no COOH group are monoester of ethoxylated or polyethoxylated 1,1,1-trimethylolpropane with acrylic or methacrylic acid, and triesters or tetraesters of dipentaerythritol with acrylic or methacrylic acid.

A further example of a polyol (B3) is bisphenol A diglycidyl ether diacrylate.

An example of a polyol (B3), wherein the ethylenically unsaturated group is an allyl group, is allyl pentaerythritol.

The polyol (B3) carrying at least one ethylenically unsaturated group and no COOH group is preferably a polyol carrying at least one acryloyl or methacryloyl group and no COOH group, more preferably a polyol carrying one to four acryloyl or methacryloyl groups and no COOH group, even more preferably a polyol carrying one to four acryloyl or methacryloyl groups and no COOH group and most preferably an aliphatic or alicyclic polyol carrying one to four acryloyl or methacryloyl groups and no COOH group.

Preferably, polyurethane (1) carrying ethylenically unsaturated groups and COOH groups, which COOH groups are at least partly in the form of a salt group thereof, does not comprise units derived from polyol (B3) carrying at least one ethylenically unsaturated group and no COOH group.

The polyol (B4) carrying no ethylenically unsaturated group and no COOH group can be any aliphatic, alicyclic or aromatic polyol (B3) carrying no ethylenically unsaturated group and no COOH group.

The OH functionality of the polyol (B4) carrying no ethylenically unsaturated group and no COOH group is preferably in the range of from 1.6 to 8.0, more preferably in the range of 1.8 to 5.4, even more preferably in the range of 1.8 to 3.4, most preferably in the range from 1.8 to 2.4, and in particular in the range of 1.9 to 2.2.

The polyol (B4) carrying no ethylenically unsaturated group and no COOH group can be either a polyol having a number average molecular weight of below 500 g/mol or a polyol having a number average molecular weight of at least 500 g/mol.

Examples of aliphatic polyols (B4) carrying no ethylenically unsaturated group and no COOH group are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol, heptane-1,7-diol, octane-1,8-diol, octane-1,2-diol, nonane-1,9-diol, decane-1,2-diol, decane-1,10-diol, dodecane-1,2-diol, dodecane-1,12-diol, hexa-1,5-diene-3,4-diol, neopentyl glycol, 2-methyl-pentane-2,4-diol, 2,4-dimethyl-pentane-2,4-diol, 2-ethyl-hexane-1,3-diol, 2,5-dimethyl-hexane-2,5-diol, 2,2,4-trimethyl-pentane-1,3-diol, pinacol and hydroxypivalinic acid neopentyl glycol ester.

Further examples of aliphatic polyols (B4) carrying no ethylenically unsaturated group and no COOH group are di(ethylene glycol), tri(ethylene glycol), di(propylene glycol) and tri(propylene glycol).

Examples of aliphatic polyols (B4) carrying no ethylenically unsaturated group and no COOH group are glycerol, trimethylolmethane, 1,1,1-trimethylolethane, 1,1,1-trimethylolpropane, 1,2,4-butanetriol and 1,3,5-tris(2-hydroxyethyl)isocyanurate, and condensates thereof with ethylene oxide, propylene oxide and/or butylene oxide.

Examples of aliphatic polyols (B4) carrying no ethylenically unsaturated group and no COOH group are pentaerythritol, diglycerol, triglycerole, condensates of at least four glycerols, di(trimethylolpropane), di(pentaerythritol), and condensates thereof with ethylene oxide, propylene oxide and/or butylene oxide.

Examples of alicyclic polyols (B4) carrying no ethylenically unsaturated group and no COOH group are 1,1-bis(hydroxymethyl)-cyclohexane, 1,2-bis(hydroxymethyl)-cyclohexane, 1,3-bis(hydroxymethyl)-cyclohexane, 1,4-bis(hydroxymethyl)-cyclohexane, 1,1-bis(hydroxyethyl)cyclohexane, 1,2-bis(hydroxyethyl)-cyclohexane, 1,3-bis(hydroxyethyl)-cyclohexan, 1,4-bis(hydroxyethyl)-cyclohexane, 2,2,4,4-tetramethyl-1,3-cyclobutandiol, cyclopentane-1,2-diol, cyclopentane-1,3-diol, 1,2-bis(hydroxymethyl) cyclopentane, 1,3-bis(hydroxymethyl) cyclopentane, cyclohexane-1,2-diol, cyclohexane-1,3-diol, cyclohexane-1,4-diol, cycloheptane-1,3-diol and cycloheptane-1,4-diol and cycloheptane-1,2-diol.

Further examples of alicyclic polyols (B4) carrying no ethylenically unsaturated group and no COOH group are inositol, sugars such as glucose, fructose and sucrose, sugar alcohols such as sorbitol, mannitol, threitol, erythritol, adonitol (ribitol), arabitol (lyxitol), xylitol, dulcitol (galactitol), malitol and isomalt, as well as tris(hydroxymethyl)amine, tris(hydroxyethyl)amine and tris(hydroxypropyl)amine.

Examples of polyols (B4) carrying no ethylenically unsaturated group and no COOH group are also polyester polyols carrying no ethylenically unsaturated group and no COOH group, polycarbonate polyols carrying no ethylenically unsaturated group and no COOH group, polyether polyols carrying no ethylenically unsaturated group and no COOH group, polythioether polyols carrying no ethylenically unsaturated group and no COOH group and polyacrylate polyols carrying no ethylenically unsaturated group and no COOH group.

Polyester polyols carrying no ethylenically unsaturated group and no COOH group are polymeric polyols carrying no ethylenically unsaturated group and no COOH group and comprising ester groups as linking groups between two monomeric units, wherein the equivalent ratio ester linking groups/all linking groups is at least 50/50, preferably at least 70/100, more preferably at least 80/100. Polyester polyols carrying no ethylenically unsaturated group and no COOH group may comprise further linking groups such as carbonate, ether, thioether or urethane groups.

Polyester polyols carrying no ethylenically unsaturated group and no COOH group can be prepared by methods known in the art, for example by reacting at least one polyacid having a COOH functionality in the range of 1.8 to 2.4 and carrying no ethylenically unsaturated group with a polyol having an OH functionality in the range of 1.8 to 2.4 and carrying no ethylenically unsaturated group and no COOH group. Examples of polyacids having a COOH functionality of 2 and carrying no ethylenically unsaturated group are aliphatic polyacids such as oxalic acid, malonic acid, succinic acid, glutaric acid, adipic acid, pimelinic acid, suberic acid, azelaic acid, sebacic acid, 1,11-undecanedicarboxylic acid, 1,12-dodecanedicarboxlylic acid, 2-methylmalonic acid, 2-ethylmalonic acid, 2-methylsuccinic acid, 2-ethylsuccinic acid, 3,3-dimethylglutaric acid, 2-phenylmalonic acid 2-phenylsuccinic acid, alicyclic polyacids such as cyclopentane-1,2-dicarboxylic acid, cyclopentane-1,3-dicarboxylic acid, cyclohexane-1,2-dicarboxylic acid, cyclohexane-1,3-dicarboxylic acid, cyclohexane-1,4-dicarboxylic acid, cycloheptane-1,2-dicarboxylic acid, 1,2-bis(carboxymethyl)-cyclohexane, 1,3-bis(carboxymethyl)-cyclohexane and 1,4-bis(carboxymethyl)-cyclohexane, and aromatic polyacids such as 2-5-furandicarboxylic acid, phthalic acid, isophthalic acid, terephthalic acid and bis(4-carboxyphenyl) methane. Examples of polyol having an OH functionality in the range of 1.8 to 2.4 and carrying no ethylenically unsaturated group and no COOH group are given above.

An example of a polyester polyol is also polycaprolactone diol.

Polycarbonate polyols carrying no ethylenically unsaturated group and no COOH group are polymeric polyols carrying no ethylenically unsaturated group and no COOH group and comprising at least two carbonate groups in the main chain of the polymer. Polycarbonate polyols carrying no ethylenically unsaturated group and no COOH group may comprise further linking groups in the main chain in lower number than the number of carbonate groups such as ester, ether, thioether or urethane linkages. Examples of polycarbonate polyols carrying no ethylenically unsaturated group and no COOH group are polycarbonates carrying no COOH group comprising units derived from the group consisting of butan-1,4-diol, pentane-1,5-diol and hexane-1,6-diol.

Preferred polycarbonate polyols carrying no ethylenically unsaturated group and no COOH group are polycarbonate polyols carrying no ethylenically unsaturated group and no COOH groups, wherein the equivalent ratio carbonate groups/all linking groups is at least 70/100, more preferably at least 80/100.

Polyether polyols carrying no ethylenically unsaturated group and no COOH group are polymeric polyols carrying no ethylenically unsaturated group and no COOH group and comprising at least two ether groups in the main chain of the polymer. Polyether polyols carrying no ethylenically unsaturated group and no COOH group may comprise further linking groups in the main chain in lower number than the number of ether groups such as ester, carbonate, thioether or urethane groups.

Preferred polyether polyols carrying no ethylenically unsaturated group and no COOH group are polyether polyols carrying no ethylenically unsaturated group and no COOH group, wherein the equivalent ratio ether groups/all linking groups is at least 70/100, more preferably at least 80/100.

Examples of polyether polyols carrying no ethylenically unsaturated group and no COOH group are polyethylene glycols, polypropylene glycol, polyethylene-polypropylene glycol, polytetramethylene diol and polytetrahydrofuran diol. Polyethylene-polypropylene glycols can be random or block copolymers Polythioether polyols carrying no ethylenically unsaturated group and no COOH group are polymeric polyols carrying no ethylenically unsaturated group and no COOH group and having at least two thioether groups in the main chain of the polymer. Polythioether polyols carrying no ethylenically unsaturated group and no COOH groups may comprise further linking groups in the main chain in lower number than the number of ether groups such as ester, carbonate, ether or urethane groups.

Poly(meth)acrylate polyols carrying no ethylenically unsaturated group and no COOH group are polymeric polyols carrying no ethylenically unsaturated group and no COOH group comprising at least two units derived from (meth)acrylic acid ester monomers carrying at least one OH group such as 2-hydroxyethyl acrylate and 2-hydroxyethyl methacrylate.

The polyol (B4) carrying no ethylenically unsaturated group and no COOH group has preferably a number average molecular weight of at least 500 g/mol, more preferably of at least 750 g/mol, even more preferably in the range of 800 to 3000 g/mol, most preferably in the range of 800 to 2000 g/mol.

The polyol (B4) carrying no ethylenically unsaturated group and no COOH group is preferably selected from the group consisting of polyester polyol carrying no ethylenically unsaturated group and no COOH group, polycarbonate polyol carrying no ethylenically unsaturated group and no COOH group and polyether polyol carrying no ethylenically unsaturated group and no COOH group. More preferably, the polyol (B4) carrying no ethylenically unsaturated group and no COOH group is a polyester polyol carrying no ethylenically unsaturated group and no COOH group or polyether polyol carrying no ethylenically unsaturated group and no COOH group.

The polyisocyanate (A1) carrying at least one ethylenically unsaturated group can be any aliphatic, alicylic or aromatic polyisocyanate carrying at least one ethylenically unsaturated group.

The NCO functionality of a polyisocyanate (A1) carrying at least one ethylenically unsaturated group is usually in the range of from 1.6 to 10.0, preferably, in the range of 1.7 to 5.4, more preferably in the range of 1.8 to 3.4, and most preferably in the range of 1.8 to 2.4.

Polyisocyanate (A1) carrying at least one ethylenically unsaturated group has preferably an ethylenically unsaturated group density in the range of 0.10 to 10.00 milliequivalents ethylenically unsaturated groups/g (A1), more preferably 0.50 to 5.00 milliequivalents ethylenically unsaturated groups/g (A1), even more preferably 1.00 to 3.00 milliequivalents ethylenically unsaturated groups/g (A1), and most preferably 1.50 to 2.50 milliequivalents ethylenically unsaturated groups/g (A1).

The ethylenically unsaturated group density of polyisocyanate (A1) is determined by ¹H-NMR by methods known in the art. The ethylenically unsaturated group density of polyisocyanate (A1) can for example be determined by ¹H-NMR using 1,4-dimethyl terephthalate as internal standard: ¹H-NMR is taken from a mixture of a specific amount of polyisocyanate (A1) carrying at least one ethylenically unsaturated group (=weight polyisocyanate) and a specific amount of 1,4-dimethyl terephthalate (=weight 1,4-dimethyl terephthalate) in a suitable solvent such as deuterated chloroform, deuterated dimethylsulfoxide or deuterated methanol. The ratio of the integrated intensity of the signal of selected protons of the ethylenically unsaturated group of the polyisocyanate (A1) to the integrated intensity of the signal of the aromatic protons of 1,4-dimethyl terephthalate is determined. The ethylenically unsaturated group density of a polyisocyanate (A1) carrying at least one ethylenically unsaturated group [mmol ethylenically unsaturated group/g polyisocyanate (A1)] is (weight of 1,4-dimethyl terephthalate× number of aromatic protons of 1,4-dimethyl terephthalate×ratio of the integrated intensity of the signal of selected protons of the ethylenically unsaturated groups of the polyisocyanate (A1) to the integrated intensity of the signal of the aromatic protons of 1,4-dimethyl terephthalate)/(molecular weight of 1,4-dimethyl terephthalate×number of selected protons of the ethylenically unsaturated group of the polyisocyanate (A1)×weight polyisocyanate). The molecular weight of 1,4-dimethyl terephthalate is 194 g/mol. The number of aromatic protons of 1,4-dimethyl terephthalate is 4. It is to be understood that depending on the type of ethylenically unsaturated group, a person skilled in the art knows which protons of an ethylenically unsaturated group to select in order to determine the ratio of the integrated intensity of the signal of the selected protons of the ethylenically unsaturated groups of the polyisocyanate (A1) to the integrated intensity of the signal of the aromatic protons of 1,4-dimethyl terephthalate. If the ethylenically unsaturated group is, for example, an acryloyl group, a person skilled in the art usually selects the terminal two protons of the acryloyl group.

The polyisocyanate (A1) preferably also comprises at least one allophanate group.

The polyisocyanate (A1) has preferably an allophanate group density in the range of 0.10 to 100.00 milliequivalents allophanate groups/g (A1), more preferably 0.50 to 50.00 milliequivalents allophanate groups/g (A1), even more preferably 0.50 to 10.00 milliequivalents allophanate groups/g (A1), most preferably 1.00 to 5.00 milliequivalents allophanate groups/g (A1), and in particular 1.00 to 3.00 milliequivalents allophanate groups/g (A1).

The allophanate group density of the polyisocyanate (A1) can be determined by NMR by methods known in the art.

The polyisocyanate (A1) carrying at least one ethylenically unsaturated group is preferably an aliphatic or alicyclic polyisocyanate.

The polyisocyanate (A1) carrying at least one ethylenically unsaturated group is preferably a polymeric polyisocyanate obtainable by the reaction of at least one polyisocyanate (A3) carrying no ethylenically unsaturated groups with at least one monoalcohol (E5) carrying one ethylenically unsaturated group.

The weight ratio polyisocyanate (A3)/monoalcohol (E5) is usually in the range of 95/5 to 50/50, preferably in the range of 90/10 to 70/30, most preferably in the range of 85/15 to 75/25.

Usually a catalyst is used in the reaction, for example N,N,N-trimethyl-N-(2-hydroxypropyl)ammonium 2-ethylhexanoate. The catalyst can be used in an amount of 10 to 500 ppm, preferably 100 to 300 ppm, based on the weight of polyisocyanate (A3).

Usually the reaction is conducted at elevated temperatures, preferably at temperatures in the range of 80 to 150° C. The reaction can be stopped when the desired NCO content is reached by distillation of unreacted polyisocyanate (A3) carrying no ethylenically unsaturated groups.

The monoalcohol (E5) carrying at least one ethylenically unsaturated group can be any monoalcohol carrying at least one ethylenically unsaturated group.

Monoalcohol (E5) has a OH functionality in the range of from 0.8 to 1.4, preferably in the range of 0.9 to 1.2.

The ethylenically unsaturated group of monoalcohol (E5) is preferably an acryloyl or methacryloyl group.

Examples of monoalcohol (E5) carrying at least one acryloyl or methacryloyl group are monoesters of diols group with acrylic acid or methacrylic acid, diesters of triols with acrylic acid or methacrylic acid and triesters of tetraols with acrylic acid or methacrylic acid and pentaesters of hexaols with acrylic acid or methacrylic acid.

Examples of monoesters of diols with acrylic or methacrylic acid are monoesters of C₁₋₁₀-aliphatic diols, preferably of C₁₋₆-aliphatic diols, with acrylic or methacrylic acid.

Examples of monoesters of C₁₋₆-aliphatic diols with acrylic or methacrylic acid are 2-hydroxyethyl methacrylate, 2-hydroxyethyl acrylate, 2-hydroxypropyl methacrylate, 2-hydroxypropyl acrylate, 3-hydroxypropyl methacrylate, 3-hydroxypropyl acrylate, 4-hydroxybutyl methacrylate and 4-hydroxylbutyl acrylate.

Further examples of monools (B5) carrying at least one ethylenically unsaturated group are diesters of ethoxylated or propoxylated 1,1,1-trimethylolpropane with acrylic or methacrylic acid, triesters of pentaerythritol with acrylic or methacrylic acid, triesters of ethoxylated or propoxylated di(1,1,1-trimethylol)propane with acrylic or methacrylic acid and pentaesters of dipentaerythritol.

Examples of monoalcohols (B5) carrying at least one allyl group and no COOH group are 2-allyloxyethanol and 2,2-bis(allyloxymethyl)butan-1-ol.

The monoalcohol (B5) carrying at least one ethylenically unsaturated group is preferably a monoalcohol carrying at least one acryloyl or methacryloyl group, more preferably a monoalcohol carrying one acryloyl or methacryloyl group. Even more preferably the monoalcohol (B5) carrying at least one ethylenically unsaturated group is an aliphatic or alicyclic monoalcohol (B5) carrying one acryloyl or methacryloyl group and no COOH group, most preferably a monoester of a C₁₋₆-aliphatic diol with acrylic acid or methacrylic acid, and in particular 2-hydroxyethyl acrylate.

Polyisocyanate (A3) carrying no ethylenically unsaturated groups can be any aliphatic, alicyclic or aromatic polyisocyanate carrying no ethylenically unsaturated groups, which polyisocyanate can be a monomeric or polymeric polyisocyanate.

The NCO functionality of a polyisocyanate (A3) is usually in the range of from 1.6 to 8.0, preferably, in the range of 1.7 to 5.4, more preferably in the range of 1.8 to 3.4, and most preferably in the range of 1.8 to 2.4.

The polyisocyanate (A3) carrying no ethylenically unsaturated groups is preferably an aliphatic or alicyclic polyisocyanate carrying no ethylenically unsaturated groups, more preferably an aliphatic polyisocyanate, and even more preferably an aliphatic polyisocyanate selected from the 40 group consisting of tetramethylene 1,4-diisocyanate, pentamethylene 1,5-diisocyanate, hexamethylene 1,6-diisocyanate, heptamethylene 1,7-diisocyanate, octamethylene 1,8-diisocyanate, and polymeric polyisocyanates carrying no ethylenically unsaturated group, having an NCO functionality in the range of 1.8 to 3.4 and comprising at least two units derived from tetramethylene 1,4-diisocyanate, pentamethylene 1,5-diisocyanate, hexamethylene 1,6-diisocyanate, heptamethylene 1,7-diisocyanate or octamethylene 1,8-diisocyanate.

Most preferably, polyisocyanate (A3) carrying no ethylenically unsaturated groups is selected from the group consisting of hexamethylene 1,6-diisocyanate and polymeric polyisocyanates carrying no ethylenically unsaturated group, having an NCO functionality in the range of 1.8 to 3.4 and comprising at least two units derived from hexamethylene 1,6-diisocyanate.

In particular, polyisocyanate (A3) carrying no ethylenically unsaturated groups is hexamethylene 1,6-diisocyanate or hexamethylene-1,6-diisocyanate trimer.

Polyisocyanate (A2) carrying no ethylenically unsaturated group can be any aliphatic, alicyclic or aromatic polyisocyanate carrying no ethylenically unsaturated groups, which polyisocyanate can be a monomeric or polymeric polyisocyanate.

The NCO functionality of a polyisocyanate (A2) carrying no ethylenically unsaturated group is usually in the range of from 1.6 to 8.0, preferably, in the range of 1.7 to 5.4, more preferably in the range of 1.8 to 3.4.

Examples of polymeric aliphatic polyisocyanate are hexamethylene 1,6-diisocyanate trimer, isophorone diisocyanate trimer and pentamethylene diisocyanate trimer.

The polymeric polyisocyanate can be prepared by methods known in the art.

The polyisocyanate (A2) carrying no ethylenically unsaturated groups is preferably an aliphatic or alicyclic polyisocyanate carrying no ethylenically unsaturated groups, more preferably an aliphatic polyisocyanate, and even more preferably an aliphatic polyisocyanate selected from the group consisting of tetramethylene 1,4-diisocyanate, pentamethylene 1,5-diisocyanate, hexamethylene 1,6-diisocyanate, heptamethylene 1,7-diisocyanate, octamethylene 1,8-diisocyanate, and a polymeric polyisocyanates carrying no ethylenically unsaturated group, having an NCO functionality in the range of 1.8 to 3.4 and comprising at least two units derived from tetramethylene 1,4-diisocyanate, pentamethylene 1,5-diisocyanate, hexamethylene 1,6-diisocyanate, heptamethylene 1,7-diisocyanate or octamethylene 1,8-diisocyanate.

In particular polyisocyanate (A2) carrying no ethylenically unsaturated groups is selected from the group consisting of hexamethylene 1,6-diisocyanate and polymeric polyisocyanates carrying no ethylenically unsaturated group, having an NCO functionality in the range of 1.8 to 3.4 and comprising at least two units derived from hexamethylene 1,6-diisocyanate.

The polyurethane (1) carrying ethylenically unsaturated groups and COOH groups, which COOH groups are at least partly in the form of a salt group thereof, preferably does not comprise units derived from polyisocyanate (A2).

The compound (C1) carrying at least one NH₂ group and no OH group can be any aliphatic, alicyclic or aromatic compound carrying at least one NH₂ group and no OH group.

Aromatic compounds (C1) are compounds (C1), wherein the at least one NH₂ functionality is directly attached to an aromatic ring. Alicyclic compounds (C1) comprise at least one alicyclic ring and each NH₂ functionality is not directly attached to an aromatic ring. Aliphatic compounds (C1) do not comprise an alicyclic ring and each NH₂ functionality is not directly attached to an aromatic ring. Preferred aliphatic and alicyclic compounds (C1) do not comprise aromatic rings.

Compounds (C1) carrying at least one NH₂ group and no OH group can also carry other functional groups such as NH, or acidic groups such as SO₃H PO₃H or COOH or salt groups thereof.

Examples of compounds (C1) are N-aminoethyl-2-aminoethanesulfonic acid, sodium salt, N-aminoethyl-2-aminoethanecarboxylic acid, sodium salt and the sodium salt of lysin.

The compound (C1) carrying at least one NH₂ group and no OH group is preferably an aliphatic or alicyclic compound carrying one NH₂ group and no OH group, more preferably an aliphatic compound carrying one NH₂ group and no OH group, and carrying at least one acidic group selected from the group consisting of SO₃H, PO₃H or COOH or salt group thereof, and most preferably an aliphatic compound carrying one NH₂ group and no OH group, and carrying one SO₃H or SO₃Na group, and in particular an aliphatic compound carrying one NH₂ group, one NH group, no OH group, and carrying one SO₃H or SO₃Na group.

Components (B1), (B2), (B3), (B4), (B5), (A1), (A2), (A3) and (C1) can be derived from fossil or from renewable resources such as plants. Whether components are derived from renewable resources or not can be determined by the C-14/C-12 isotope ratio.

The polyurethane (1) carrying ethylenically unsaturated groups and COOH groups, which COOH groups are at least partly in the form of a salt group thereof, preferably has a number average molecular weight Mn in the range of 750 g/mol to 30000 g/mol, more preferably in the range of 1000 g/mol to 15000 g/mol, even more preferably in the range of 1500 g/mol to 15000 g/mol.

The polyurethane (1) carrying ethylenically unsaturated groups and COOH groups, which COOH groups are at least partly in the form of a salt group thereof, preferably has a weight average molecular weight Mw in the range of 3000 g/mol to 50000 g/mol, more preferably in the range of 5000 g/mol to 30000 g/mol, even more preferably in the range of 6000 g/mol to 20000 g/mol, most preferably in the range of 7000 g/mol to 15000 g/mol.

The number average molecular weight Mn and the weight average molecular weight Mw are determined using gel permeation chromatography calibrated to a polystyrene standard.

The salt group of the COOH group can be any salt group of the COOH group formed by the reaction of the COOH group with a base.

The base can be an inorganic base or compound carrying at least one tertiary amino group.

Examples of inorganic bases are alkali and alkaline earth metal hydroxide, alkali and alkaline earth metal carbonate as well as alkali and alkaline earth metal hydrogencarbonate. Preferred inorganic bases are alkali metal hydroxide such as sodium or potassium hydroxide, alkali metal carbonate such as sodium carbonate and potassium carbonate as well as alkali metal hydrogencarbonate such as sodium hydrogen carbonate and potassium hydrogen carbonate.

Examples compounds carrying at least one tertiary amino group are triethanolamine, tripropanolamine, N-methyldiethanolamine, N-ethyldiethanolamine, N,N-dimethylethanolamine, N,N-diethylethanolamine, triethylamine, ethyldiisopriopylamine, tripropylamine, triisopropylamine and tri-n-butylamine.

The salt group of the COOH group is preferably an alkali metal salt of the COOH group, more preferably the sodium or potassium salt of the COOH group, and most preferably the sodium salt of the COOH group.

The equivalent ratio of salt groups of COOH groups/(COOH groups and salt groups thereof) of polyurethane (1) is preferably in the range of from 40/100 to 100/100, and more preferably in the range of from 60/100 to 100/100.

The COOH groups and salt groups thereof density of the polyurethane (1) is preferably at least 0.20 milliequivalents COOH groups and salt groups thereof/g of polyurethane (1), and more preferably at least 0.30 milliequivalents COOH groups and salt groups thereof/g of polyurethane (1), and most preferably in the range of from 0.35 to 0.50 milliequivalents COOH groups and salt groups thereof/g solids of polyurethane (1).

The COOH groups and salt groups thereof density of the polyurethane (1) is the sum of
[weight ratio (B1)/(A1), (1), (B2), (B3), (B4), (A1), (A2), (A3) and (C1)] multiplied with the COOH group density of (1) and
[weight ratio (B2)/(A1), (1), (B2), (B3), (B4), (A1), (A2), (A3) and (C1)] multiplied with the COOH group density of (B2) and
[weight ratio (C1)/(A1), (1), (E2), (E3), (E4), (A1), (A2), (A3) and (C1)] multiplied with the COOH group density of (C1).

The ethylenically unsaturated group density of the polyurethane (1) is preferably at least 0.50 milliequivalents ethylenically unsaturated group/g polyurethane (1), and more preferably at least 1.00 milliequivalents ethylenically unsaturated group/g polyurethane (1), and even more preferably in the range of from 1.50 to 5.00 milliequivalents ethylenically unsaturated group/g polyurethane (1), and most preferably in the range of from 2.00 to 3.00 milliequivalents ethylenically unsaturated group/g polyurethane (1).

The ethylenically unsaturated group density of the polyurethane (1) is determined by calculation. The ethylenically unsaturated group density of the polyurethane (1) is the sum of
[weight ratio (B1)/((A1), (1), (E2), (E3), (E4), (A1), (A2) and (C1)] multiplied by ethylenically unsaturated group density of (1)],
[weight ratio (B2)/(A1), (1), (E2), (E3), (E4), (A1), (A2) and (C1)] multiplied by ethylenically unsaturated group density of (E2)],
[weight ratio (B3)/(A1), (1), (E2), (E3), (E4), (A1), (A2) and (C1)] multiplied by the ethylenically unsaturated group density of (E3)],
[weight ratio (A1)/(A1), (1), (B2), (B3), (B4), (A1), (A2) and (C1)] multiplied by ethylenically unsaturated group density of (A1)] and
[weight ratio (C1)/(A1), (1), (E2), (E3), (E4), (A1), (A2) and (C1)] multiplied by ethylenically unsaturated group density of (C1).

The ethylenically unsaturated group densities of (1), (E2), (E3), (A1) and (C1) can be determined by ¹H-NMR by methods known in the art.

Polyurethane (1) preferably also comprises allophanate groups.

If allophanate groups are present, the allophanate group density of the polyurethane (1) is preferably in the range of at least 0.10 to 200.00 milliequivalents allophanate group/g of polyurethane (1), and more preferably in the range of 0.50 to 60.00 milliequivalents allophanate group/g polyurethane (1), and even more preferably in the range of from 0.70 to 10.00 milliequivalents allophanate group/g polyurethane (1), and most preferably in the range of from 0.80 to 5.00 milliequivalents allophanate group/g polyurethane (1).

The allophanate group density of the polyurethane (1) is determined by calculation.

The allophanate group density of the polyurethane (1) is the sum of
[weight ratio (A1)/(A1), (1), (E2), (E3), (E4), (A1), (A2) and (C1)] multiplied by allophanate group density of (A1) and
[weight ratio (A2)/(A1), (1), (B2), (B3), (B4), (A1), (A2) and (C1)] multiplied by the allophanate group density of (A2).

The allophanate group densities of (A1), and (A2) can be determined by NMR by methods known in the art.

The at least one polyurethane (1) carrying ethylenically unsaturated groups and COOH groups, which COOH groups are at least partly in the form of a salt group thereof, is preferably obtainable by the reaction of
0.5 to 30% by weight of at least one polyol (1) carrying at least one COOH group,
1 to 60% by weight of at least monoalcohol (B2) carrying at least one ethylenically unsaturated group and no COOH group,
0 to 40% by weight of at least polyol (B3) carrying at least one ethylenically unsaturated group and no COOH group,
5 to 80% by weight of at least one polyol (B4) carrying no ethylenically unsaturated group and no COOH group,
5 to 90% by weight of at least one polyisocyanate (A1) carrying at least one ethylenically unsaturated group,
0 to 50% by weight of at least one polyisocyanate (A2) carrying no ethylenically unsaturated group, and
0 to 30% by weight of at least one compound (C1) carrying at least one NH₂ group and no OH group,
in each case based on the sum of weights of (1), (B2), (B3), (B4), (A1), (A2) and (C1).

The at least one polyurethane (1) carrying ethylenically unsaturated groups and and COOH groups, which COOH groups are at least partly in the form of a salt group thereof, is more preferably obtainable by the reaction of
1 to 20% by weight of at least one polyol (1) carrying at least one COOH group,
5 to 50% by weight of at least monoalcohol (E2) carrying at least one ethylenically unsaturated group and no COOH group,
0 to 30% by weight of at least polyol (E3) carrying at least one ethylenically unsaturated group and no COOH group,
5 to 60% by weight of at least one polyol (E4) carrying no ethylenically unsaturated group and no COOH group,
15 to 85% by weight of at least one polyisocyanate (A1) carrying at least one ethylenically unsaturated group,
0 to 40% by weight of at least one polyisocyanate (A2) carrying no ethylenically unsaturated group, and
0 to 15% by weight of at least one compound (C1) carrying at least one NH₂ group and no OH group, in each case based on the sum of weights of (1), (B2), (B3), (B4), (A1), (A2) and (C1).

The at least one polyurethane (1) carrying ethylenically unsaturated groups and COOH groups, which COOH groups are at least partly in the form of a salt group thereof, is even more preferably obtainable by the reaction of
1 to 10% by weight of at least one polyol (1) carrying at least one COOH group,
5 to 25% by weight of at least monoalcohol (B2) carrying at least one ethylenically unsaturated group and no COOH group,
0 to 5% by weight of at least polyol (B3) carrying at least one ethylenically unsaturated group and no COOH group,
10 to 40% by weight of at least one polyol (B4) carrying no ethylenically unsaturated group and no COOH group,
30 to 80% by weight of at least one polyisocyanate (A1) carrying at least one ethylenically unsaturated group,
0 to 10% by weight of at least one polyisocyanate (A2) carrying no ethylenically unsaturated group, and
0 to 5% by weight of at least one compound (C1) carrying at least one NH₂ group and no OH group
in each case based on the sum of weights of (1), (B2), (B3), (B4), (A1), (A2) and (C1).

The at least one polyurethane (1) carrying ethylenically unsaturated groups and COOH groups, which COOH groups are at least partly in the form of a salt group thereof, is most preferably obtainable by the reaction of
1 to 10% by weight of at least one polyol (1) carrying at least one COOH group,
5 to 25% by weight of at least monoalcohol (E2) carrying at least one ethylenically unsaturated group and no COOH group,
0% by weight of at least polyol (E3) carrying at least one ethylenically unsaturated group and no COOH group,
10 to 40% by weight of at least one polyol (E4) carrying no ethylenically unsaturated group and no COOH group,
40 to 80% by weight of at least one polyisocyanate (A1) carrying at least one ethylenically unsaturated group,
0 to 10% by weight of at least one polyisocyanate (A2) carrying no ethylenically unsaturated group, and
0 to 3% by weight of at least one compound (C1) carrying at least one NH₂ group and no OH group,
in each case based on the sum of weights of (1), (B2), (B3), (B4), (A1), (A2) and (C1).

The equivalent ratio of NCO group of polyisocyanate (A1) and (A2)/OH groups of components (1), (B2), (B3) and (B4) is preferably in the range of 1.01/1.00 to 1.30/1.00, most preferably in the range of 1.02/1.00 to 1.20/1.00.

The equivalent ratio of NCO group of polyisocyanate (A1) and (A2)/OH groups of components (1), (B2), (B3) and (B4) and NCO-reactive groups other than OH provided by component (C1) is usually in the range of 1.00/1.00 to 1.50/1.00, preferably in the range of 1.01/1.00 to 1.30/1.00, more preferably in the range of 1.02/1.00 to 1.20/1.00.

Examples of NCO-reactive groups other than OH provided by component (C1) are NH₂, NH and SH.

Compound (2) carrying at least one ethylenically unsaturated group and no COOH group usually also does not carry NCO groups or groups that are reactive towards NCO. Examples of groups that are reactive towards NCO groups are OH, SH, NH₂ and NH groups.

Compound (2) has preferably a number average molecular weight of below 1000 g/mol. The number average molecular weight can be determined using gel permeation chromatography calibrated to a polystyrene standard.

Compound (2) preferably has a boiling point of more than 200° C. at 101325 Pa (standard pressure).

Compound (2) preferably has a melting point of less than 0° C. at at 101325 Pa (standard pressure).

The ethylenically unsaturated group functionality of compound (2) is usually in the range of 0.8 to 6.5, preferably in the range of 0.8 to 4.4 and more preferably in the range of 1.8 to 4.4.

The ethylenically unsaturated group functionality of compound (2) can be calculated by multiplying the ethylenically unsaturated group density of compound (2) with the number average molecular weight of compound (2). The ethylenically unsaturated group density of compound (2) can be determined by ¹HNMR by methods known in the art.

Examples of compound (2) are styrene, p-tert-butylstyrene, p-methylstyrene, o-methylstyrene, 2-vinylnaphthalene, divinylstyrene, butadiene, isoprene, chloroprene, ethylene, propylene, 1-butene, 2-butene, isobutene, cylopentene, cyclohexene, cyclododecene, vinyl acetate, vinyl propionate, vinyl chloride and vinylidene chloride, N-vinyl formamide, N-vinylacetamide, N-vinyl-N-methyl formamide, N-vinyl-N-methyl-acetamide, N-vinyl pyrrolidone, N-vinyl caprolactam, ethylene glycol divinyl ether, di(ethylene glycol) divinyl ether, tri(ethylene glycol) divinyl ether, trimethylolpropane trivinyl ether, 1,4-cyclohexanedimethanol divinyl ether, methyl vinyl ether, ethyl vinyl ether, isopropyl vinyl ether, isobutyl vinyl ether, tert-amyl vinyl ether, dodecyl vinyl ether, 1,4-butanediol divinyl ether, 1,6-hexanediol divinyl ether, cyclohexyl vinyl ether, allyl acetate, diallyl phthalate, triallylcyanurate, trimethylolpropane triallyl ether, alpha, beta unsaturated C₄₋₁₀-dicarboxylic acids such as maleic acid, fumaric acid, itaconic acid, citraconic acid, mesaconic acid and 2-methylenglutaric acid as well as salts thereof, esters of alpha, beta unsaturated C₄₋₁₀-dicarboxylic acids such as dimethyl ester of maleic acid, ethyl methyl ester of maleic, diethyl ester of maleic acid, dimethyl ester of fumaric acid, the ethyl methyl ester of fumaric acid and the diethyl ester of fumaric acid, alpha, beta unsaturated nitriles such as (meth)acrylonitrile, and alpha, beta unsaturated aldehydes such as (meth)acrolein, and alpha, beta unsaturated amides such as (meth)acrylamide, alpha, beta unsaturated C₃₋₈-carboxylic acids such as acrylic acid, methacrylic acid and 3,3-dimethyl acrylic acid as well as salts thereof.

Further examples of compound (2) are compounds carrying at least one (meth)acryloyl group are C₁₋₂₀-alkyl(meth)acrylate such as methyl(meth)acrylate, ethyl(meth)acrylate, n-propyl(meth)acrylate, butyl(meth)acrylate, isobutyl(methacrylate), sec-butyl(meth)acrylate, tertbutyl(meth)acrylate, pentyl(meth)acrylate, isopentyl(meth)acrylate, 2-methylbutyl(meth)acrylate, amyl(meth)acrylate, hexyl(meth)acrylate, 2-ethylbutyl(meth)acrylate, heptyl(methacrylate, octyl (meth)acrylate, 2-ethylhexyl(meth)acrylate, 2-propylheptyl(meth)acrylate, nony(meth)acrylate), decyl(methacrylate), isodecyl(methacrylate), undecyl(meth)acrylate and dodecyl(meth)acrylate, tridecyl (meth)acrylate, tetradecyl(meth)acrylate, pentadecyl (meth)acrylate, hexadecyl (meth)acrylate, heptadecyl (meth)acrylate, octadecyl (meth)acrylate and nonadecyl(meth)acrylate, C₅₋₁₂-cycloalkyl(meth) acrylate such as cyclopentyl(meth)acrylate, cyclohexyl(meth)acrylate and cycloheptyl (meth)acrylate, acetoacetoxy(C₂-6-alkyl) (meth)acrylates such as acetoacetoxyethyl (meth)acrylate, acetoacetoxypropyl (meth)acrylate and acetoacetoxybutyl (meth)acrylate, [C₁₋₁₀-alkoxy(C₁₋₁₀-alkoxy)_{0.5}]C₁₋₁₀-alkyl(methacrylate) such as 2-methoxyethyl(meth)acrylate, 2-ethoxyethyl(meth)acrylate, 4-methoxybutyl(meth)acrylate, 2-(2′-methoxyethoxy)ethyl(meth)acrylate and 2-(2′-ethoxyethoxy)ethyl(meth)acrylate, 2-norbornyl (meth)acrylate, dihydrodicyclopentadienyl (meth)acrylate, 4-tetrahydropyranyl (meth)acrylate, 2-tetrahydropyranyl (meth)acrylate, tetrahydrofuryl (meth)acrylate, diesters of C₁₋₂₀-diols with (meth)acrylic acid such as 1,2-ethyleneglycol di(meth)acrylate, 1,2-propyleneglycol di(meth)acrylate, 1,3-propyleneglycol di(meth)acrylate, 1,2-butanediol di(meth)acrylate, 1,3-butanediol-di(meth)acrylate, 1,4-butanediol di(meth)acrylate, neopentylglycol di(meth)acrylate, 1,6-hexanediol di(meth)acrylate, 1,7-heptandiol di(methacrylate), 1,8-octanediol di(methacrylate), 1,9-nonanediol di(meth)acrylate, 1,10-decanediol di(methacrylate), 1,2-bis(hydroxymethyl)-cyclohexane di(methacrylate), 1,4-bis(hydroxymethyl)-cyclohexane di(methacrylate and cyclohexan-1,4-diol di(meth)acrylate, diesters of ethoxylated and/or propoxylated C₁₋₂₀-diols with (meth)acrylic acid such ethoxylated and/or propoxylated 1,2-butanediol di(meth)acrylate, ethoxylated and/or propoxylated 1,4-butanediol di(meth)acrylate, ethoxylated and/or propoxalted neopentylglycol di(methacrylate), ethoxylated and/or propoxylated 1,4-bis(hydroxymethyl)-cyclohexane di(methacrylate), diethyleneglycol di(meth)acrylate, triethylene glycol di(meth)acrylate, tetraethylene glycol di(meth)acrylate, dipropylene glycol di(meth)acrylate, tripropylene glycol di(meth)acrylate, tetrapropylene glycol di(meth)acrylate as well as polyethylene glycols di(methacrylate), polypropylene glycols di(meth)acrylate, polyethylene-polypropylene glycol di(meth)acrylate, the sequence of the ethylene oxide or propylene oxide units being blockwise or random, polytetramethyleneglycol di(meth)acrylate, polytetrahydrofurane di(meth)acrylate, and ethoxylated or propoxylated bisphenol A di(methacrylate), glycerol tri(meth)acrylate, 1,1,1-trimethylolpropane tri(meth)acrylate, 1,1,1-trimethylolethane tri(meth)acrylate, pentaerythritol tetra(meth)acrylate, di(1,1,1-trimethylolpropane) tetra(meth)acrylate and dipentaerythritol hexa(meth)acrylate, ethoxylated and/or propoxylated glycerol tri(meth)acrylate, ethoxylated and/or propoxylated 1,1,1-trimethylolpropane tri(meth)acrylate, ethoxylated and/or propoxylated pentaerythritol tetra(meth)acrylate, ethoxylated and/or propoxylated di(1,1,1-trimethylolpropane) tetra(meth)acrylate and ethoxylated and/or propoxylated dipentaerythritol hexa(meth)acrylate.

The term “(meth)acryloyl” comprises acryloyl and methacryolyl.

The composition of the present invention can also comprise polymerization inhibitors.

Examples of polymerization inhibitors are 2,2,6,6-tetramethylpiperidine-1-oxyl (TEMPO), 4-hydroxy-2,2,6,6-tetramethylpiperidine-1-oxyl (TEMPOL), 4-benzoyloxy-2,2,6,6-tetramethylpiperidine-1-oxyl, 4-benzyloxy-2,2,6,6-tetramethylpiperidine-1-oxyl, 2,2-diphenyl-1-picryl-hydrazyl (DPPH), tris(p-nitrophenyl)methane, p-phenylenediamines such as N,N′-diphenyl-p-phenylenediamine, phenothiazine, hydroxylamines such as N,N-diethylhydroxylamine DEHA), quinones such as hydroquinone (HQ), hydroquinone monomethyl ether, 1,4-benzoquinone, tertbutylhydroquinone, 2,5-bis(1,1,3,3-tetramethylbutyl)hydroquinone, 2,5-bis(1,1-dimethylbutyl)hydroquinone, p-tert-butylcatechol (TBC) and 4-methoxyphenol (MEHQ), alkylated phenols such as 2,6-di-tert-butylphenol, 2,4-di-tert-butylphenol, 2,4,6-tri-tert-butylphenol, 2-tert-butyl-4,6-dimethylphenol and 2,6-di-tert-butyl-4-methylphenol.

The composition of the present invention usually comprises polyurethane (1) in the range of 10 to 70% by weight based on the composition, more preferably in the range of 20 to 60% by weight based on the weight of the composition, even more preferably in the range of 30 to 50% by weight based on the weight of the composition and most preferably in the range of 35 to 45% by weight based on the weight of the composition.

The composition of the present invention usually comprises water in the range of 30 to 90% by weight based on the weight of the composition, more preferably of in the range of 80 to 40% by weight based on the weight of the composition, even more preferably of in the range of 70 to 50% by weight based on the weight of the composition and most preferably in the range of 65 to 55% by weight based on the weight of the composition.

The composition of the present invention usually comprises below 10% by weight organic solvents, more preferably below 5% by weight based on the weight of the composition.

The composition of the present invention can comprise compound (2) in the range of 0 to 50% by weight based on the weight of the composition, more preferably in the range of 0 to 30% by weight based on the weight of the composition and even more preferably in the range of 0 to 20% by weight based on the weight of the composition. Most preferably compound (2) is not present in the composition of the present invention.

The composition of the present invention can comprise polymerization inhibitors in the range of 0.001 to 5.000% by weight based on the weight of polyurethane (1), more preferably in the range of 0.005 to 2.000% by weight based on the weight of polyurethane (1) and even more preferably in the range of 0.010 to 1.000% by weight based on the weight of polyurethane (1).

The composition of the present invention can be a dispersion or a solution. Examples of dispersions are emulsions (liquid pase dispersed in liquid phase) and suspensions (solid phase dispersed in liquid phase).

The composition of the present invention is preferably a dispersion, more preferably a dispersion having an average particle size in the range of 1 to 200 nm, more preferably in the range of 5 to 150 nm and most preferably in the range of 10 to 100 nm. The average particle size is determined using dynamic light scattering (DLS) ISO 22412, 2017.

Also part of the present invention is a process for the preparation of the composition of the present invention, which process comprises the steps of
(i) reacting at least one polyol (1) carrying at least one COOH group, at least one monoalcohol (B2) carrying at least one ethylenically unsaturated group, optionally at least one polyol (B3) carrying at least one ethylenically unsaturated group and no COOH group,
at least one polyol (B4) carrying no ethylenically unsaturated group and no COOH group,
at least one polyisocyanate (A1) carrying at least one ethylenically unsaturated group, and optionally at least one polyisocyanate (A2) carrying no ethylenically unsaturated group,
in at least one organic solvent to form a polyurethane prepolymer (3) carrying ethylenically unsaturated groups and COOH groups,
(ii) optionally reacting the composition comprising polyurethane prepolymer (3) of step (i) with at least one compound (C1) carrying at least one NH₂ group and no OH group to form a composition comprising polyurethane prepolymer (4) carrying ethylenically unsaturated groups and COOH groups,
(iii) reacting at least part of the COOH groups of the polyurethane prepolymer (3) of the composition of step (i), or of the polyurethane prepolymer (4) of the composition of step (ii) with a base to form a composition comprising polyurethane (1) carrying ethylenically unsaturated groups and COOH groups, which COOH groups are at least partly in the form of a salt group thereof, and
(iv) adding water to the composition of polyurethane (1) of step (iii) and removing the at least one organic solvent to obtain the composition of the present invention, wherein the equivalent ratio of ethylenically unsaturated group provided by polyisocyanate (A1)/ethylenically unsaturated groups provided by components (B1), (B2), (B3), (A1) and (C1) is in the range of from 0.20/1.00 to 0.95/1.00.

The organic solvent of step (i) can be an aliphatic ketone such as acetone, ethyl methylketone (2-butanone) or isobutyl methyl ketone, an aliphatic amide such as N-methylpyrrolidone or N-ethylpyrrolidone, an ether such as tetrahydrofuran, dipropylene glycol dimethyl ether or dioxane, a hydrocarbon such as n-heptane, cyclohexane, toluene, ortho-xylene, meta-xylene, paraxylene, and xylene isomer mixture, an ester such as butyl acetate, an acid such as acetic acid or a nitrile such as acetonitrile, or a mixture thereof.

The at least one organic solvent is preferably an aliphatic ketone, and more preferably an aliphatic ketone selected from the group consisting of acetone and ethyl methyl ketone (2-butanone).

Step (i) is usually performed in the presence of polymerization inhibitors.

Step (i) can be performed in the presence of at least one catalyst. Preferably, no catalyst is used in step (i).

Examples of catalysts are amine catalysts carrying at least one tertiary amino group and organometal catalysts.

Examples of amine catalysts carrying at least one tertiary amino group are 1,4-diazabicyclo[2.2.2]octane, N-methylmorpholine, N-methylimidazole, bis[2-(N,N-dimethylamino)ethyl]ether, 2,2′-dimorpholinyldiethylether and tetramethylethylenediamine, dimethylcyclohexylamine, dimethylbenzylamine, dimethylethanolamine and dimethylaminopropyl amine.

Examples of organometallic catalysts are organo titanium catalysts, organo tin catalysts, organo zinc catalysts, organo bismuth catalysts, organo zirconium catalysts, organo iron catalysts, organo aluminum catalysts, organo manganese catalysts, organium nickel catalysts, organo cobalt catalysts, organo molybdenum catalysts, organo tungsten catalysts and organo vanadium catalysts.

Examples of organo titanium catalysts are titanium(IV) tetra(isopropoxide) and titanium(IV) tetra(butoxide). Examples of organo tin catalyst are tin(II) diacetate, tin(II) di(2-ethylhexanoate), tin(II) dilaurate, dimethyltin(IV) diacetate, dibutyltin(IV) diacetate, dibutyltin(IV)dibutyrate, dibutyltin di(2-ethylhexanoate), dibutyltin(IV) dilaurate, dioctyltin(IV) dilaurate, dioctyltin(IV) diacetate, dibutyl tin(IV) oxide, diphenyl tin(IV) oxide, dibutyltin(IV) dichloride, and dibutyl tin(IV) maleate. Examples of organo zinc catalyst are zinc(II) diacetate, zinc(II) di(2-ethylhexanoate) and zinc(II) dineodecanoate. Examples of organo bismuth catalyst are bismuth(II) diacetate, bismuth(II) dipivalate, bismuth(II) di(2-ethylhexanoate) and bismuth(II) dineodecanoate. Examples organo zirconium catalysts are zirconium(IV) tetra(acetylacetonate) and zirconium(IV) tetrakis(2,2,6,6-tetramethyl-3,5-heptanedionate).

Step (i) is usually performed at elevated temperatures, such as at temperatures in the range of 70 to 150° C., preferably in the range of 70 to 100° C., more preferably in the range of 75 to 90° C.

Step (i) is usually stopped when an NCO content of below 2% by weight, preferably below 1% by weight, based on the weight of the reaction mixture is reached by addition of at least one organic solvent, which can be the same than the organic solvent of step (i) or different.

The equivalent ratio of NCO group of polyisocyanate (A1) and (A2)/OH groups of components (B1), (B2), (B3) and (B4) in step (i) is usually in the range of 1.00/1.00 to 1.50/1.00, preferably in the range of 1.01/1.00 to 1.30/1.00, most preferably in the range of 1.02/1.00 to 1.20/1.00.

Step (ii), if performed, is usually performed at temperatures below 80° C.

If step (ii) is performed, the equivalent ratio of OH group of (1), (B2), (B3) and (B4))/isocyanate-reactive groups of components (C1), is usually in the range of 50/1 to 2/1, preferably in the range of 30/1 to 5/1.

The base used in step (iii) can be any base. Examples of bases are given above. The base is preferably an alkali metal hydroxide, more sodium or potassium hydroxide, and most preferably the sodium hydroxide.

The equivalent ratio of alkali metal hydroxide/COOH groups of polyurethane prepolymer (3) or (4) is preferably in the range of from 40/100 to 100/100 and most preferably in the range of from 60/100 to 100/100.

Step (iv) is usually performed under rapid stirring of the composition.

If compound (2) is present in the composition of the present invention, step (i) can be performed in the presence of compound (2). Compound (2) can also be added after step (i), for example between step (i) or step (ii), or between step (iii) and step (iv). It is also possible to add part of compound (2) in step (i), and the other part of compound (2) later.

Also part of the present invention is an aqueous coating composition comprising the composition of the present invention comprising polyurethane (1), at least one additive, optionally at least one initiator and optionally at least one polymer (5) different from polyurethane (1), wherein the coating composition comprises polyurethane (1) in the range of 10 to 70% by weight based on the weight of the coating composition.

The additive can be any suitable additive.

Examples of additives are thickeners, ultraviolet absorbers, light stabilizers, surfactants, polymerization inhibitors, photosensitizers, curing catalyst, antifoamers, plasticizers, fillers, pigments, dyes, flow control agents, antioxidants, flame retardents, antistatic agents, thixotropic agents, leveling agents, tackifiers, chelating agents, matting agents and compatibilizers.

Examples of thickeners are hydroxymethyl cellulose and bentonite. Examples of ultraviolet absorbers are benzotriazoles such as 2-(3-tert-butyl-2-hydroxy-5-methylphenyl)-5-chlorobenzotriazole, 2-(2H-benzotriazol-2-yl)-4-(1,1,3,3-tetramethylbutyl) phenol and 2-(2H-benzotriazol-2-yl)-p-cresol, triazines such as 2-(4,6-diphenyl-1,3,5-triazin-2-yl)5-((hexyl)oxy) phenol), cyanoacrylates and benzophenones. Examples of light stabilizers are hindered amine light stabilizers (HALS) such as 2,2,6,6-tetramethylpiperidine, 2,6-di-tert-butylpiperidine and bis(2,2,6,6-tetramethyl-4-piperidyl) sebacate. Examples of fillers are talc, siliceous earth, clay, aluminium silicates, magnesium silicate, calcium carbonate, calcium sulfate, barium sulfate, aluminium hydroxide aluminium oxide and organic fillers such as polyacrylic acid and cellulose. Examples of chelating agents are ethylenediamine tetraacetic acid and p-diketones.

The initiator is a compound that forms free radical upon heat treatment (thermal radical initiator) or upon radiation (photoinitiator).

Examples of thermal radical initiators are peroxides such as potassium persulfate, dibenzoyl peroxide, cyclohexanone peroxide, di-tert-butyl peroxide, acetyl cyclohexylsulfonyl peroxide, di-iso-propyl percarbonate, tert-butyl peroctoate, cumene hydroperoxide, dicumyl peroxide and tert-butyl perbenzoate, azobis-iso-butyronitrile and benzpinacol.

Examples photoinitiators are acetophenone, 2,2-dimethoxy-2-phenylacetophenone (benzil dimethyl ketal), 2,2-diethoxyacetophenone, 4-dimethylaminoacetophenone, benzophenone, 2,4,6-trimethylbenzophenone, 4-methylbenzophenone 4-hydroxybenzophenone, 4-phenylbenzophenone, 2-chlorobenzophenone, 4,4′-bis(diethylamino)benzophenone, thioxanthone, isopropyl-9H-thioxanthen-9-one, phenyl glyoxylic acid methyl ester, benzoin, benzoin methyl ether, benzoin ethyl ether, benzoin n-propylether, benzoin isopropylether, benzoin n-butyl ether, benzoin isobutyl ether, benzoin dimethyl ketal, cyclohexyl phenyl ketone, 1-hydroxy-cyclohexyl phenyl ketone, p-isopropyl-2-hydroxyisobutyrophenone, 2-hydroxy-2-methyl-1-phenyl-1-propanone, oligo[2-hydroxy-2-methyl-1-[4-(1-methylvinyl)phenyl]propanone], 2-benzyl-2-dimethylamino 1-(4-morpholinophenyl) butanone-1, 2-benzyl-2-dimethylamino-1-(4-morpholinophenyl)-1-butanone, 2-methyl-1-(4-methylthiophenyl)-2-morpholinopropan-1-one, 4-(2-hydroxyethoxy)phenyl 2-hydroxy-2-propyl ketone, acylphosphine oxides such as diphenyl(2,4,6-trimethylbenzoyl) phosphine oxide, phenyl bis(2,4,6-trimethylbenzoyl) phosphine oxide and bis(2,6-dimethoxybenzoyl)-2,4,4 trimethylpentylphosphine oxide, methyl-2-benzoyl benzoate and ethyl phenyl(2,4,6-trimethylbenzoyl) phosphinate.

It is also possible to use mixtures of initiators. Examples of mixtures of initiators are mixtures of at least two photoinitiators, mixtures of at least one photoinititiator and at least one thermal radical initiator as well as mixtures of at least two thermal radical initiators.

Common mixtures of photoinitiators are the mixture of bis(2,6-dimethoxybenzoyl)-2,4,4 trimethylpentylphosphine oxide and 2-hydroxy-2-methyl-1-phenyl-1-propanone, the mixture of 1-hydroxy-cyclohexyl phenyl ketone and benzophenone, the mixture of bis(2,6-dimethoxybenzoyl)-2,4,4-trimethylpentylphosphine oxide and 1-hydroxy-cyclohexyl phenyl ketone, the mixture of diphenyl (2,4,6-trimethylbenzoyl) phosphine oxide and 2-hydroxy-2-methyl-1-phenyl-1-propanone, the mixture of 2,4,6-trimethylbenzophenone and 4-methylbenzophenone, and the mixture of 4-methylbenzophenone and diphenyl (2,4,6-trimethylbenzoyl) phosphine oxide.

The at least one initiator is preferably a photoinitiator, more preferably a UV photoinitiator. A UV photoinitiator is an initiator that forms free radicals upon UV radiation treatment. Preferred initiators are selected from the group consisting of diphenyl (2,4,6-trimethylbenzoyl) phosphine oxide, ethyl phenyl (2,4,6-trimethylbenzoyl) phosphinate, benzophenone, phenyl bis(2,4,6-trimethylbenzoyl) phosphine oxide, 1-hydroxy-cyclohexyl phenyl ketone, 2-hydroxy-2-methyl-1-phenyl-1-propanone and 2,2-dimethoxy-2-phenylacetophenone (benzil dimethyl ketal).

The polymer (5) can be any polymer different from polyurethane (1). Polymer (5) can be a polymer carrying ethylenically unsaturated groups or a polymer not carrying ethylenically unsaturated groups. Examples of polymer (5) are polyurethanes, acrylic polymers, hybrids of polyurethane and acrylic polymer, polyesters, polyethers, polycarbonates, epoxy resins, alkyd resins, polyolefins and polyvinylacetate, as well as acrylated or methacrylated derivatives thereof.

If polymer (5) is a polymer not carrying ethylenically unsaturated groups, the hydroxyl value of polymer (5) is preferably in the range of from 1 to 300 mg KOH/g and the acidic value is preferably below 50 mg KOH/g.

Acrylated and methacrylated derivatives can be prepared by methods known in the art, for example by esterifying the OH-groups of polyesters, acrylic polymers and polyethers with acrylic acid or methacrylic acid, or by ring-opening the epoxy groups of epoxy resin with acrylic acid or methacrylic acid.

Polyurethanes are polymers comprising urethane linkages. Polyurethanes are usually obtained by reaction of diols with diisocyanates. The diol can be a polyester diol, acrylic polymer diol, polycarbonate diol or polyetherdiol. Polyurethanes may comprise further linking groups in the main chain in lower number than the number of urethane groups such as ester, ether, thioether or urethane linkages. Acrylated or methacrylated polyurethanes can also be obtained using acrylated or methacrylated alcohols or diols as synthesis component.

Acrylic polymers are usually obtained by radical polymerization from polymerizable unsaturated monomers comprising acrylic acid esters or methacrylic acid esters, and optionally other polymerizable unsaturated monomers, by methods known in the art such as emulsion polymerization. Examples of other polymerizable unsaturated monomers are polymerizable unsaturated monomers carrying OH groups such as 2-hydroxyethyl (meth)acrylate, 2-hydroxypropyl (meth)acrylate, 3-hydroxypropyl (meth) acrylate, 4-hydroxybutyl (meth)acrylate and (meth)allyl alcohol, and polymerizable unsaturated monomers carrying acidic groups such as acrylic acid, methacrylic acid, maleic acid, citraconic acid, itaconic acid, maleic anhydride, citraconic anhydride and itaconic anhydride. Preferably the polymerizable unsaturated monomers also comprise polymerizable unsaturated monomers carrying OH groups. The hydroxyl value of the acrylic polymers is preferably in the range from 1 to 200 mg KOH/g, more preferably in the range of 2 to 100 mg KOH/g, and most preferably 3 to 50 mg KOH/g. The weight average molecular weight of the acrylic polymer is preferably 1000 to 200000 g/mol, more preferably 2000 to 100000 g/mol, and most preferably 3000 to 50000 g/mol.

Hybrids of polyurethane and acrylic polymer can be obtained, for example, by preparing the acrylic polymer as described above, but in the presence of a polyurethane.

Polyesters are polymers comprising monomers linked via an ester linkage. Polyesters are usually obtained by an esterification reaction or transesterification reaction of a component carrying two acidic groups and a diol. Polyesters may comprise linking groups other the ester groups in lower number or equal than the number of ester groups such as carbonate, ether, thioether or urethane linking groups. The hydroxyl value of the polyester is preferably about 1 to 300 mg KOH/g, more preferably about 50 to 250 mg KOH/g, and still more preferably about 80 to 180 mg KOH/g. The acid value of the polyester resin is preferably about 1 to 200 mg KOH/g, more preferably about 15 to 100 mg KOH/g, and still more preferably below 50 mg KOH/g. The weight average molecular weight of the polyester is preferably 500 to 500000 g/mol, more preferably 1000 to 300000 g/mol, and still more preferably 1500 to 200000 g/mol.

Polyethers are polymers comprising ether linkages. Polyethers are usually prepared by acid catalyzed polymerization of ethers such as ethyleneoxide, propylene oxide, butylene oxide or tetrahydrofuran using an alcohol. Examples of polyethers are polyoxyethylene polyether, polyoxypropylene polyether, polyoxybutylene polyether and polytetrahydrofuran. Polyethers may comprise further linking groups in the main chain in lower number than the number of ether groups such as ester, carbonate, thioether or urethane linkages.

Polycarbonates are polymers comprising carbonate linkages. Polycarbonates are usually obtained by reaction of carbonates with diols. Polycarbonates may comprise further linking groups in the main chain in lower number than the number of carbonate groups such as ester, ether, thioether or urethane linkages.

Epoxy resins are polymers carrying epoxy groups. Epoxy polymers can be obtained by reaction of polyols with epichlorohydrin followed by dehydrohalogenation. Examples of polyols are bisphenol A and bisphenol F as well as novolak resins, which are polymers formed by reaction of phenol with formaldehyde.

Alkyd resins are polyester carrying fatty acid-derived groups. Alkyd resins are usually obtained by an esterification reaction or transesterification reaction of a component carrying two acidic groups, a polyol and a glycerine fatty acid triester. Examples of components carrying two acidic groups are phthalic anhydride and maleic anhydride. Examples of polyols are trimethylolpropane, glycerine and pentaeryhritol. Examples of glycerine fatty acid triester are soybean oil, linseed oil and coconut oil.

Polyolefins are polymers obtainable by polymerizing at least one olefin monomer, optionally in the presence of at least a polymerizable unsaturated monomer which is not an olefin monomer, by methods known in the art such as emulsion polymerization. Olefin monomers are monomers comprising solely H and C atoms. Examples of olefin monomers are ethylene, propylene, 1-butene, 3-methyl-1-butene, 4-methyl-1-pentene, 3-methyl-1-pentene, 1-heptene, 1-hexene, 1-decene and 1-dodecene; conjugated dienes and non-conjugated dienes such as butadiene, ethylidene norbornene, dicyclopentadiene and 1,5-hexadiene, and styrenes. Examples of polymerizable unsaturated monomers, which are no olefin monomers, are vinyl acetate, vinyl alcohol, maleic acid, citraconic acid, itaconic acid, maleic anhydride, citraconic anhydride and itaconic anhydride.

Preferred polymers (5) are selected from the group consisting of polyurethanes, acrylic polymers, hybrids of polyurethane and acrylic polymer, as well as acrylated or methacrylated derivatives thereof.

The coating composition of the present invention usually comprises polyurethane (1) in the range of 10 to 70% by weight based on the coating composition, more preferably of in the range of 15 to 50% by weight based on the weight of the coating composition, most preferably of in the range of 20 to 45% by weight based on the weight of the coating composition.

The coating composition of the present invention usually comprises additives in the range of 0.05 to 40% by weight based on the coating composition and most preferably of in the range of 0.1 to 20% by weight based on the weight of the coating composition.

The coating composition of the present invention preferably comprises at least one initiator in the range of 0.05 to 7.0% by weight based on the weight of polyurethane (1), more preferably in the range of 0.1 to 5.0% by weight based on the weight of the polyurethane (1).

The coating composition of the present invention usually comprises polymer (5) in the range of 0 to 50% by weight based on the coating composition, more preferably in the range of 0 to 25% by weight based on the coating composition.

The coating composition of the present invention usually comprises at least 20% by weight, more preferably at least 40% by weight water based in the weight of the coating composition.

The coating composition of the present invention usually comprises below 10% by weight organic solvents based on the weight of the coating composition.

The coating composition can be a dispersion or a solution. Preferably the coating composition is a dispersion.

In one preferred embodiment, coating composition of the present invention is a primer composition, preferably a primer composition not comprising pigments.

In another preferred embodiment, the coating composition of the present invention as a pigmented wood stain composition.

The coating composition of the present invention can be prepared by mixing the composition of the present invention, the at least one additive, the at least one initiator, optionally the least one polymer (5), and optionally additional water. The at least one additive, the at least one initiator and, if present, the at least one polymer (5) can be used “as is” or as a solution or dispersion in an organic solvent and/or in water in the mixing step. Polymers (5), which are selected from the group consisting of polyurethanes, acrylic polymers, hybrids of polyurethane and acrylic polymer, as well as acrylated or methacrylated derivatives thereof, are usually used as aqeuous solution or dispersion in the mixing step.

Also part of the present invention is a crosslinked-layer formed from the coating composition of the present invention.

The cross-linked layer is obtainable by a process, which comprises the steps of (i) applying the coating composition of the present invention to a substrate to form a layer, (ii) optionally drying the layer of step (i), and (iii) treating the layer of step (i) or of step (ii) with heat, radiation or electron beam to form a cross-linked layer.

The coating compositions of the present invention can be applied to the substrate by any method known in the art such as by draw down bar, spraying, troweling, knifecoating, brushing, rolling, rollercoating, flowcoating and laminating, doctor blades, various printing processes such as gravure, transfer, lithographica and ink jet printing and by using a bar.

The layer obtained directly after application of the coating composition on the substrate has preferably a thickness in the range of 20 to 500 micrometer, more preferably in the range of 40 to 300 micrometer, most preferably in the range of 60 to 240 micrometer, and in particular 60 to 200 micrometers.

The layer obtained directly after application of the coating composition on the substrate is commonly referred to as wet layer.

The layer of step (i) can be dried in step (ii) to remove at least most of the water (and other volatiles such as organic solvents).

The layer obtained after removal of at least most of the water (and other volatiles such as organic solvents) is commonly referred to as dried layer.

Step (ii), if present, is preferably performed at temperatures in the range of 15 to 160° C. more preferably in the range of 40° C. to 160° C. In case a thermal radical initiator is present in the coating composition, drying conditions (temperature and time) are preferably chosen that do not activate the thermal radical initiator.

The layer of step (i) or of step (ii) is treated in step (iii) with electron beam, heat or radiation to form a cross-linked layer. Heat can also be applied by near infrared (NIR) radiation, for example radiation having a wavelength in the range of 760 to 2500 nm. Preferably, the layer of step (i) or (ii) is treated with ultraviolet radiation, daylight or electron beam. More preferably, the layer of step (i) or (ii) is treated with radiation having a wavelength in the range of 200 to 700 nm, even more preferably in the range of fro 200 to 500 nm, and most preferably in the range of 250 to 400 nm.

Examples of radiation sources are low-pressure mercury vapor lamps, medium-pressure mercury vapor lamps, high-pressure mercury vapor lamps, lasers, pulsed lamps (flashlight), halogen lamps and excimer lamps. The radiation dose is normally chosen to be sufficient for crosslinking. In case of UV radiation, a radiation dose of 80 to 3000 mJ/cm², preferably 100 to 2000 mJ/cm² is usually used. A combination of different radiation sources is also possible.

Step (iii) can be performed either in the presence of oxygen or, preferably, in the absence of oxygen such as under inert gas atmosphere. Suitable inert gases are nitrogen, argon and carbon dioxide. The layer of step (i) or (ii) can also be covered with transparent media such as a transparent polymer film, glass or water and irradiated through the transparent media. Irradiation can also be performed by passing the substrate coated with the layer of step (i) or (ii) at constant speed past a radiation source.

In a preferred embodiment step (ii) is performed and in step (iii) the layer of step (ii) is treated with radiation to form a cross-linked layer.

Steps (i), optionally (ii) and (iii) can be repeated yielding a multi-layered cross-linked layer.

The substrate can be any suitable substrate. The substrate can be wood substrates, engineered wood substrates, engineered bamboo substrates, engineered cellulosic substrates other than engineered wood or bamboo substrates, fibre-reinforced composite substrates (FRC), wood-plastic composite substrates (WPC), plastic substrates such as melamine formaldehyde substrate, paper substrates, recycled paper substrates, paperboard (also called cardboard) substrate, recycled paperboard (also called recycled cardboard) substrates, metal substrates, stone substrate, glass substrates, textiles substrates, leather substrates, ceramic substrates, mineral building material substrates such as molded cement blocks and fiber-cement slabs. The substrates can be precoated with a coating composition different from the coating composition of the present invention. Preferably, the substrate is not pre-coated with a coating composition different from the coating composition of the present invention.

Examples of wood substrates are oak, beech, maple, alder, ash, pine tree, fir tree, spruce, chestnut, Robinia, birch, elm, teak, walnut and cockroaches as well as cork.

Wood can, for example, be in the form of lumber (also called timber), in the form of planks used for flooring, for example parquet flooring, in the form of devices used for house construction or domestic applications, or in the form of solid wood furnitures. Cork can be, for example, in the form of tiles used for flooring, or in the form of devices used for domestic applications.

Engineered wood substrates are derivative wood substrates manufactured by binding or fixing the strands, particles, fibres, veneers or boards of wood with adhesives or other methods of fixation to form composite materials. Examples of adhesives are urea-formaldehyde resin, phenol formaldehyde resin, melamine formaldehyde resin, polymeric methylene diphenyl diisocyanate, polyvinyl acetate and polyurethane. Examples of engineered wood substrates are guelaminated timber, cross-laminated timber (CLT), parallel strand lumber (PSL), laminated strand lumber (LSL), laminated veneer lumber (LVL), plywood, oriented strand board (OSB), composite panels, particle board (also called flakeboard or chipboard), fibreboard such as hardboard (also called high-density fibreboard, HDF) and medium density fibreboard (MDF).

Engineered wood substrates can be in the form of lamella used for engineered wood flooring, for example laminate flooring, in the form of devices used for house construction or domestic applications, and in the form of furniture such as flat-pack furniture.

Engineered bamboo substrates are derivative bamboo substrates manufactured by binding or fixing parts of bamboo with adhesives or other methods of fixation to form composite materials. An example of engineered bamboo substrate is laminated bamboo.

Engineered cellulosic substrates other than engineered wood substrates and bamboo substrates are products from lignin-containing materials other than wood and bamboo such as rye straw, wheat straw, rice straw, hemp stalks, kenaf stalks and sugar cane residue, manufactured by binding or fixing parts of the lignin-containing materials other than wood and bamboo with adhesives or other methods of fixation to form composite materials.

Fibre-reinforced composite substrates (FRC) are made from rice-derived fibres and plastic.

Wood-plastic composites (WPCs) are composite materials made from fibres or flour of wood and thermoplastic polymers such as polyethylene, prolypropylene, polyvinyl chloride or polyacetic acid.

Preferably, the substrate is selected from the group consisting of wood substrates, engineered wood substrates, engineered bamboo substrates, engineered cellulosic substrates other than engineered wood or bamboo substrates, fibre-reinforced composite substrates (FRC), wood-plastic composite substrates (WPC), plastic substrates such as melamine formaldehyde substrate, paper substrates, recycled paper substrates, paperboard (also called cardboard) substrate, recycled paperboard (also called recycled cardboard) substrates.

More preferably, the substrate is selected from the group consisting of wood substrates, engineered wood substrates, engineered bamboo substrates, engineered cellulosic substrates other than engineered wood or bamboo substrates.

Even more preferably, the substrate is selected from the group consisting of wood substrates, and engineered wood substrates. Most preferably, the substrate is selected from the group consisting of wood substrates and engineered wood substrates comprising veneer such as veneer plates. In particular, the substrate is selected from the group consisting of oak substrates and engineered wood substrates comprising oak veneer such as oak veneer plates.

Also part of the present invention is a substrate coated with the layer of the present invention.

Also part of the present invention is the use of the coating composition of the present invention as primer composition, preferably as a primer composition not comprising pigments.

Also part of the present invention is the use of the coating composition of the present invention as pigmented wood stain composition.

The compositions of the present invention, and in particular the coating compositions of the present invention, are advantageous in that the compositions form a wet layer, for example on black glass plate, that has already a good transparency.

The compositions of the present invention, and in particular the coating compositions of the present invention comprising polyurethanes comprising also units derived from component C1, are in particular advantageous in that the compositions form a wet layer, for example on black glass plates, that is clear and thus shows a high transparency.

The compositions of the present invention, and in particular the coating compositions of the present invention, are advantageous in that the dried layers formed from the compositions on substrates, for example on glass plates, are re-dispersible or re-soluble in water at ambient temperatures for a certain period. This allows the removal of dried residues formed from the compositions on machines and equipment used to apply the compositions on a substrate.

The compositions of the present invention, and in particular the coating compositions of the present invention, are also advantageous in that the layers, in particular the dried layers formed from the compositions on substrates are re-dispersible or re-soluble in the composition itself at ambient temperatures for a certain period.

The compositions of the present invention, and in particular the coating compositions of the present invention, are also advantageous in that the cross-linked layer formed from the compositions on substrates, in particular on wood substrate or on engineered wood substrate comprising veneer such as oak veneer plates, shows a high water resistance.

The compositions of the present invention, and in particular the coating compositions of the present invention are also advantageous in that the cross-linked layer formed from the compositions on substrates, in particular on wood substrate or on engineered wood substrate comprising veneer such as oak veneer plates, shows a good anfeuerung

The compositions of the present invention, and in particular the coating compositions of the present invention, are also advantageous in that the cross-linked layer formed from the compositions on a substrate, for example on black glass plates, is clear and thus shows a high transparency.

The compositions of the present invention, and in particular the coating compositions of the present invention, show a favourable combination of redispersibility or re-solubility of the dried layer before crosslinking, and at the same time high water resistance of the cross-linked layer on wood substrates and on engineered wood substrate comprising veneer such as oak veneer plates.

The compositions of the present invention, and in particular the coating compositions of the present invention, show a favourable combination of redispersibility or re-solubility of the dried layer before crosslinking, and at the same time high water resistance as well as a good anfeuerung of the cross-linked layer on wood substrates and on engineered wood substrate comprising veneer such as oak veneer plates.

The compositions of the present invention, and in particular the coating compositions of the present invention, show a favourable combination of redispersibility or re-solubility of the dried layer before crosslinking, and at the same time high water resistance and good anfeuerung of the cross-linked layer on wood substrates and on engineered wood substrates comprising veneer such as oak veneer plates, as well as good to high transparency of the wet layer as well as high transparency of the cross-linked layer.

### EXAMPLES

NCO content of a compound or of a composition [weight NCO/weight compound or composition] is determined by first treating the compound/composition with di-n-butyl amine and then back-titrating unreacted di-n-butylamine in order to determine the amount of reacted di-n-butyl amine. The following method can be used: 10 mL of a 1 N solution of di-n-butyl amine in xylene is added to 1 g of the compound/composition to be analyzed dissolved in 100 mL of N-methylpyrrolidone. The resulting mixture is stirred at room temperature for five minutes. Then, the resulting reaction mixture is subjected to back titration using 1 N hydrochloric acid to measure the volume of the hydrochloric acid needed for neutralizing the unreacted di-n-butyl amine. This then reveals how much mol di-n-butyl amine reacted with NCO groups. The NCO content is (mol reacted di-n-butyl amine×molecular weight of NCO)/weight compound/composition. The weight of the compound/composition is 1 g. The molecular weight of NCO is 42 g/mol.

Ethylenically unsaturated group density of polyisocyanate (A1) [milliequivalent ethylenically unsaturated groups/g polyisocyanate (A1)] is determined by ¹H-NMR using 1,4-dimethyl terephthalate as internal standard. ¹H-NMR is taken from a mixture of a specific amount of polyisocyanate (A1) carrying at least one ethylenically bond (=weight polyisocyanate) and and a specific amount of 1,4-dimethyl terephthalate (=weight 1,4-dimethyl terephthalate) in deuterated chloroform. The ratio of the integrated intensity of the signal of selected protons of the ethylenically unsaturated groups provided by polyisocyanate (A1) to the integrated intensity of the signal provided by the aromatic protons of 1,4-dimethyl terephthalate is determined. The ethylenically unsaturated group density of a polyisocyanate (A1) carrying at least one ethylenically unsaturated group [mmol ethylenically unsaturated groups/g polyisocyanate (A1)] is (weight of 1,4-dimethyl terephthalate×number of aromatic protons of 1,4-dimethyl terephthalate×ratio of the integrated intensity of the signal of selected protons of the ethylenically unsaturated groups provided by polyisocyanate (A1) to the integrated intensity of the signal of the aromatic protons provided by 1,4-dimethyl terephthalate)/(molecular weight of 1,4-dimethyl terephthalate×number of selected protons of the ethylenically unsaturated group of the polyisocyanate (A1)×weight polyisocyanate). The molecular weight of 1,4-dimethyl terephthalate is 194 g/mol. The number of aromatic protons of 1,4-dimethyl terephthalate is 4. The selected protons of the ethylenically unsaturated groups provided by polyisocyanate (A1) are the terminal two protons of the acryloyl group.

Allophanate group density of polyisocyanate (A1) carrying at least one ethylenically unsaturated bond [milliequivalent allophanate groups/g polyisocyanate (A1)] is determined by NMR by methods known in the art.

Ethylenically unsaturated group density of a polyurethane [milliequivalent ethylenically unsaturated groups/g polyurethane] is determined by calculation. The ethylenically unsaturated group density of a polyurethane is the sum of [weight ratio (B1)/(A1), (1), (E2), (E3), (E4), (A1), (A2) and (C1) multiplied by ethylenically unsaturated group density of (1)] and [weight ratio (B2)/(A1), (1), (B2), (B3), (B4), (A1), (A2) and (C1) multiplied by ethylenically unsaturated group density of (B2)] and [weight ratio (B3)/(A1), (1), (E2), (E3), (E4), (A1), (A2) and (C1) multiplied by the ethylenically unsaturated group density of (E3)] and [weight ratio (A1)/(A1), (1), (E2), (E3), (E4), (A1), (A2) and (C1) multiplied by ethylenically unsaturated group density of (A1)] and [weight ratio (C1)/(A1), (1), (B2), (B3), (B4), (A1), (A2) and (C1) multiplied by ethylenically unsaturated group density of (C1)].

COOH group and salt groups thereof density of a polyurethane [milliequivalents COOH and salt group thereof/g PU] is determined by calculation. The COOH group and salt groups thereof density of a polyurethane is the sum of
[weight ratio (B1)/(A1), (1), (E2), (E3), (E4), (A1), (A2), (A3) and (C1)] multiplied with the COOH group density of (1) and
[weight ratio (B2)/(A1), (1), (E2), (E3), (E4), (A1), (A2), (A3) and (C1) multiplied with the COOH group density of (E2)] and
[weight ratio (C1)/(A1), (1), (E2), (E3), (E4), (A1), (A2), (A3) and (C1)] multiplied with the COOH group density of (C1).

The number average molecular weight Mn and the weight average molecular weight Mw are determined using gel permeation chromatography calibrated to a polystyrene standard.

### Example 1

Preparation of polyisocyanate A1a comprising at least one ethylenically unsaturated group Hexamethylene diisocyanate was introduced under nitrogen into a reaction vessel. 20 mol % (based on hexamethylene diisocyanate) of 2-hydroxyethyl acrylate was added. The mixture was heated to 80° C., and 200 weight ppm (based on HDI) of N,N,N-trimethyl-N-(2-hydroxypropyl)ammonium 2-ethylhexanoate was added. The temperature rose slowly to 120° C., and the reaction was conducted at this temperature and stopped when the NCO content reached 26.0 weight % based on the weight of the reaction mixture by adding 250 weight ppm (based on HDI) of di(2-ethylhexyl) phosphate. Unreacted hexamethylene diisocyanate was removed using a thin film evaporator at 135° C. and 2.5 mbar to yield polyisocyanate A1a having an NCO content of 15.0 weight %, a weight average molecular weight (Mw) of 563.48 g/mol, an average NCO functionality of 2.0, an ethylenically unsaturated group density of 2.15 milliequivalents ethylenically unsaturated bonds/g A1a and an allophanate group density of 1.74 milliequivalents allophanate group/g A1a.

### Example 2

### Preparation of an Aqueous Polyurethane Dispersion PUD1a Comprising Polyurethane 1a

46.64 g 2,2-bis(hydroxymethyl) propionic acid, 146.55 g of a polytetrahydrofuran (MW 1000 g/mol), 89.34 g 2-hydroxyethyl acrylate, 0.8 g Kerobit®TBK (polymerization inhibitor), 0.08 g 2,2,6,6-tetramethylpiperidine-1-oxyl (polymerization inhibitor) and 200 g butanone were mixed at 22° C. 516.59 g of the polyisocyanate A1a of example 1 was added, the temperature was increased to 80° C., and the reaction mixture was allowed to react until an NCO content of 0.33 weight % based on the weight of the reaction mixture was reached. The mixture was diluted with 372 g acetone, which leads to a drop in temperature of below 80° C. 111.59 g of a 10 weight % solution of NaOH in water was added to the mixture and the reaction mixture was allowed to react for 5 min. 1150 g Water was added to the reaction mixture under rapid stirring. The organic solvents were removed by distillation to yield an aqueous composition PUD1a comprising polyurethane 1a having a solid content of 40.3 weight %, and the properties as shown in table 1.

### Comparative Example 1

### Preparation of a Comparative Aqueous Polyurethane Dispersion cPUD1 Comprising Comparative Polyurethane c1

51.96 g 2,2-bis(hydroxymethyl) propionic acid, 44.57 g of a polytetrahydrofuran (MW 1000 g/mol), 231.84 g 2-hydroxyethyl acrylate, 0.8 g Kerobit®TBK (polymerization inhibitor), 0.08 g 2,2,6,6-tetramethylpiperidine-1-oxyl (polymerization inhibitor) and 200 g butanone were mixed at 22° C. 396.33 g hexamethylendiisocyanate trimer (NCO content: 22 weight %), 75.18 g hexamethylene diisocyanate was added, the temperature was increased to 80° C., and the reaction mixture was allowed to react until an NCO content of 0.4 weight % based on the weight of the reaction mixture was reached. The mixture was diluted with 372 g acetone, which leads to a drop in temperature of below 80° C. 124.1 g of a 10 weight % solution of NaOH in water was added to the mixture (80% degree of neutralization) and the reaction mixture was allowed to react for 10 min. 1150 g Water was added to the reaction mixture under rapid stirring. The organic solvents were removed by distillation to yield an aqueous composition cPUD1 comprising polyurethane c1 having a solid content of 40.3 weight %, and the properties as shown in table 1.

### Comparative Example 2

### Preparation of a Comparative Aqueous Polyurethane Dispersion cPUD2 Comprising Comparative Polyurethane c2

49.17 g 2,2-bis(hydroxymethyl) propionic acid (DMPA), 126.42 g of a polytetrahydrofuran (MW 1000 g/mol), 167.35) g 2-hydroxyethyl acrylate, 0.8 g Kerobit®TBK (polymerization inhibitor) 0.08 g 2,2,6,6-tetramethylpiperidine-1-oxyl (polymerization inhibitor) and 200 g butanone were mixed at 22° C. 393.27 g Basonat® HA 3000 (available from BASF, allophanate-modified polyisocyanate based on isocyanurated hexamethylendiisocyanate and carrying no ethylenically unsaturated groups, NCO content: 19 weight %) and 63.79 g hexamethylene diisocyanate were added, the temperature was increased to 80° C., and the reaction mixture was allowed to react until an NCO content of 0.37 weight % based on the weight of the reaction mixture was reached. The mixture was diluted with 372 g acetone, which leads to a drop in temperature of below 80° C. 117.42 g of a 10 weight % solution of NaOH in water was added to the mixture (80% degree of neutralization) and the reaction mixture was allowed to react for 10 min. 1150 g Water was added to the reaction mixture under rapid stirring. The organic solvents were removed by distillation to yield an aqueous composition cPUD2 comprising polyurethane c2 having a solid content of 39.6 weight %, and the properties as shown in table 1.

### Example 3

### Preparation of an Aqueous Polyurethane Dispersion PUD1b Comprising Polyurethane 1b

39.85 g 2,2-bis(hydroxymethyl) propionic acid, 144.18 g of a polytetrahydrofuran (MW 1000 g/mol), 87.9 g 2-hydroxyethyl acrylate, 0.8 g Kerobit®TBK (polymerization inhibitor), 0.08 g 2,2,6,6-tetramethylpiperidine-1-oxyl (polymerization inhibitor) and 200 g butanone were mixed at 22° C. 508.23 g of the polyisocyanate A1a of example 1 was added, the temperature was increased to 80° C., and the reaction mixture was allowed to react until an NCO content of 0.6 weight % based on the weight of the reaction mixture was reached. The mixture was diluted with 370 g acetone, which leads to a drop in temperature of below 80° C. 18.97 g of a 50 weight % solution of N-aminoethyl-2-aminoethanesulfonic acid, sodium salt in water was added to the mixture and the reaction mixture was allowed to react for 10 min. 95.36 g of a 10 weight % solution of NaOH in water was added to the mixture and the reaction mixture was allowed to react for 5 min. 1150 g Water was added to the reaction mixture under rapid stirring. The organic solvents were removed by distillation to yield an aqueous composition PUD1b comprising polyurethane 1b having a solid content of 40.6 weight %, and the properties as shown in table 1.

### Comparative Example 3

### Preparation of a Comparative Aqueous Polyurethane Dispersion cPUD3 Comprising Comparative Polyurethane c3

39.72 g dimethylolpropionic acid (DMPA), 123.49 g of a polytetrahydrofuran (MW 1000 g/mol), 163.48 g 2-hydroxyethyl acrylate, 0.8 g Kerobit®TBK (polymerization inhibitor), 0.08 g 2,2,6,6-tetramethylpiperidine-1-oxyl (polymerization inhibitor) and 200 g butanone were mixed at 22° C. 384.00 g Basonat® HA 3000 (available from BASF, allophanate-modified polyisocyanate, based on hexamethylendiisocyanate, and not carrying ethylenically unsaturated groups, NCO content: 19 weight %), 62.24 g hexamethylene diisocyanate was added, the temperature was increased to 80° C., and the reaction mixture was allowed to react until an NCO content of 0.98% based on the weight of the reaction mixture was reached. The mixture was diluted with 372 g acetone, which leads to a drop in temperature of below 80° C. 26.00 g of a 50 weight % solution of N-aminoethyl-2-aminoethanesulfonic acid, sodium salt in water was added to the mixture and the reaction mixture was allowed to react for 10 min. 95.02 g of a 10 weight % solution of NaOH in water was added to the mixture and the reaction mixture was allowed to react for 5 min. 1150 g Water was added to the reaction mixture under rapid stirring. The organic solvents were removed by distillation to yield an aqueous composition cPUD3 comprising polyurethane c3 having a solid content of 40.2 weight %, and the properties as shown in table 1.

### Example 4

### Preparation of an Aqueous Polyurethane Dispersion PUD1c Comprising Polyurethane 1c

39.85 g 2,2-bis(hydroxymethyl) propionic acid, 144.18 g of a Lupraphen® 6800/2 (aliphatic polyester diol from BASF SE having a hydroxyl number of 112 mg KOH/g), 87.9 g 2-hydroxyethyl acrylate, 0.8 g Kerobit TBK (polymerization inhibitor), 0.08 g 2,2,6,6-tetramethylpiperidine-1-oxyl (polymerization inhibitor) and 200 g butanone were mixed at 22° C. 508.23 g of the polyisocyanate A1a of example 1 was added, the temperature was increased to 80° C., and the reaction mixture was allowed to react until an NCO content of 0.6 weight % based on the weight of the reaction mixture was reached. The mixture was diluted with 370 g acetone, which leads to a drop in temperature of below 80° C. 18.97 g of a 50 weight % solution of N-aminoethyl-2-aminoethanesulfonic acid, sodium salt in water was added to the mixture and the reaction mixture was allowed to react for 10 min. 95.36 g of a 10 weight % solution of NaOH in water was added to the mixture and the reaction mixture was allowed to react for 5 min. 1150 g Water was added to the reaction mixture under rapid stirring. The organic solvents were removed by distillation to yield an aqueous composition PUD1c comprising polyurethane 1c having a solid content of 41.5 weight %, and the properties as shown in table 1.

### Example 5

### Preparation of an Aqueous Polyurethane Dispersion PUD1d Comprising Polyurethane 1d

39.85 g 2,2-bis(hydroxymethyl) propionic acid, 144.18 g of a Lupraphen® 7800/1 (polyester diol from BASF SE, hydroxyl value: 112 mg KOH/g), 87.9 g 2-hydroxyethyl acrylate, 0.8 g Kerobit TBK (polymerization inhibitor), 0.08 g 2,2,6,6-tetramethylpiperidine-1-oxyl (polymerization inhibitor) and 200 g butanone were mixed at 22° C. 508.23 g of the polyisocyanate A1a of example 1 was added, the temperature was increased to 80° C., and the reaction mixture was allowed to react until an NCO content of 0.6 weight % based on the weight of the reaction mixture was reached. The mixture was diluted with 370 g acetone, which leads to a drop in temperature of below 80° C. 18.97 g of a 50 weight % solution of N-aminoethyl-2-aminoethanesulfonic acid, sodium salt in water was added to the mixture and the reaction mixture was allowed to react for 10 min. 95.36 g of a 10 weight % solution of NaOH in water was added to the mixture and the reaction mixture was allowed to react for 5 min. 1150 g Water was added to the reaction mixture under rapid stirring. The organic solvents were removed by distillation to yield an aqueous composition PUD1d comprising polyurethane 1d having a solid content of 39.2 weight %, and the properties as shown in table 1.

### Examples 6

Preparation of coating compositions comprising the aqueous polyurethane dispersions PUD1a, PUD1b, PUD1c and PUD1d of examples 2, 3, 4 and 5, respectively, and of comparative coating compositions comprising the comparative aqueous polyurethane dispersions cPUD1, cPUD2 and cPUD3 of comparative examples 1, 2 and 3, respectively.

The aqueous polyurethane dispersions PUD1a, PUD1b, PUD1c and PUD1d of examples 2, 3, 4 and 5, respectively, and the comparative aqueous polyurethane dispersions cPUD1, cPUD2 and cPUD3 of comparative examples 1, 2 and 3, respectively, were diluted with water to a solid content of 35 weight %. 1 weight part Irgacure® 1173 (photoinitiator, available from BASF) was mixed with 1 weight part of Byk-346 (silicone surfactant). 100 g of the diluted aqueous polyurethane dispersions (35 weight %) were mixed with 2.0 g of the 1/1 (weight/weight) mixture of Irgacure® 1173 and Byk-346, and 10.0 g Rheovis® PU 1340 (thickener, available from BASF) using a Speedmixer™ (type DAC 400-1 FVZ, by Hauschild) at a speed of approximately 2000 rpm for 4 minutes to yield coating compositions. The coating compositions were stored at room temperature overnight and used the next day for the application tests described in examples 7 to 10.

### Example 7

### Preparation of Black Glass Plates Coated with the Coating Compositions of Example 6

The coating compositions of example 6 were remixed manually using a wooden spatula and applied on the surface of a black glass plate using a 100-micrometer double box film applicator to form a layer. The transparency of the wet layer, which is the layer immediately after being applied, was analyzed by visual inspection and classified as follows:
1: white
2: milky/white
3: milky
4: clear
60 Minutes after applying the coating compositions, the dried layer was treated with UV radiation using a Hg lamp with a lamp power of 50% (2×10 m/minute, dose of approximately 1200 mJ/cm²) to form a cross-linked layer. After cooling down to room temperature, the transparency of the cross-linked layer was analyzed immediately by visual inspection and classified as follows:
1: turbid, pinholes
2: turbid
3: clear

The results are outlined in table 1.

### Example 8

### Preparation of Glass Plates Coated with the Coating Compositions of Example 6

The coating compositions of example 6 were remixed manually using a wooden spatula and were applied on the surface of a long glass plate using a 200-micrometer small box film applicator to form a wet layer. The layer on the long glass plate was dried at room temperature for 10 minutes, and then at 50° C. for 15 minutes in a convection drying cabinet.

After the long glass plates were cooled down to room temperature, approximately one third of the long glass plates was hold under a jet of demineralized water for 20 seconds with the d layer upwards, followed by immediate dabbing of the upward side of the water-treated parts of the long glass plates with a paper tissue.

Whether the dried layer was removed or not on the dabbed upward side of the water-treated parts of the long glass plates was analyzed by visual inspection, and classified as follows:
No: dried layer is not removed or only partly removed
Yes: dried layer is removed
The results are outlined in table 1.

### Example 9

### Preparation of Veneered Oak Plates Coated with the Coating Compositions of Example 6

The coating compositions of example 6 were remixed manually using a wooden spatula and were applied on the surface of veneered oak plates using a 100-micrometer wide box film applicator to form a wet layer. The layer on the oak veneer plates was dried at room temperature for 10 minutes, and then at 50° C. for 15 minutes in a convection drying cabinet.

After drying the dried layers on the oak veneer plates were cooled down to room temperature, the dried layer was treated with UV radiation using a Hg with a lamp power of 50% (2×10 m/minute, dose of approximately 1200 mJ/cm²) to form a cross-linked layer. The cross-linked layer was grinded with P400 sandpaper, and the coating process was repeated once more using the described procedure.

The water resistance (1 hour water exposure) was tested by placing a water column (diameter: approximately 2.5 cm, height: approximately 4.0 cm) on the surface of the cross-linked layer of the veneered oak plate. This was done with the aid of a 50 mL-penicillin jar (diameter: approximately 2.5 cm, height: approximately 8 cm) which was half filled with water. After 1 hour the water column was removed and the appearance of the part of the cross-linked layer of the veneered oak plate exposed to water for 1 hour was analyzed immediately and also after 24 hours standing at room temperature by visual inspection.

The water resistance (16 hours water exposure) was tested by placing a water column (diameter: approximately 2.5 cm, height: approximately 4.0 cm) on the surface of the cross-linked layer of the veneered oak plate. This was done with the aid of a 50 ml penicillin jar (diameter: 2.5 cm, height: 8 cm) which was half filled with water. After 16 hours the water column was removed and the appearance of the part of the cross-linked layer of the veneered oak plate exposed to water for 16 hours was analyzed immediately and also after 24 hours standing at room temperature by visual inspection.

The appearance the part of the cross-linked layer of the veneered oak plate exposed to water was classified as follows:
1: strong marks visible; the structure of the surface is changed
2: strong marks visible; the structure of the surface is largely intact
3: slight change in gloss and color; the structure of the surface is not changed, visible swelling
4: just noticeable changes in brightness and color at minimum one angle of view, no visible but tactile swelling
5: no visible changes at all possible angles of view

The results are outlined in table 1.

### Example 10

Preparation of veneered oak plates coated with the coating compositions of example 6 Veneered oak plates coated with the coating composition of example 6 were prepared as described in example 9.

The anfeuerung was determined as follows: After UV radiation treatment, the veneered oak plates were cooled to room temperature, and the anfeuerung of the coated veneered oak plate was analyzed by visual inspection and classified as follows:
1: no anfeuerung
2: very low anfeuerung
3: low anfeuerung
4: good anfeuerung
5: very good anfeuerung

The results are outlined in table 1.

TABLE 1
The higher the value shown in the table for examples 7 to 10, the better the property.

| | Coating compositions of ex 6 | | | | | | |
|---|---|---|---|---|---|---|---|
| PUD | PUD1a | cPUD1 | cPUD2 | PUD1b | cPUD3 | PUD1c | PUD1d |
| (C1) | no | no | no | yes | yes | yes | yes |
| DB density PU^{a)} | 2.35 | 2.50 | 1.80 | 2.34 | 1.79 | 2.34 | 2.34 |
| DB (A1)/DB(PU)^{b)} | 0.59/1.00 | 0 | 0 | 0.59/1.00 | 0 | 0.59/1.00 | 0.59/1.00 |
| NCO/OH ^{c)} | 1.04/1.00 | 1.04/1.00 | 1.04/1.00 | 1.10/1.00 | 1.20/1.00 | 1.10/1.00 | 1.10/1.00 |
| COOH density PU^{d)} | 0.44 | 0.48 | 0.46 | 0.38 | 0.38 | 0.38 | 0.38 |
| Mn PU [g/mol] | 2939 | 1981 | 1913 | 2123 | 1866 | 2123 | 2600 |
| Mw PU [g/mol] | 14266 | 6035 | 5712 | 11942 | 4824 | 8678 | 8389 |

Example 7 (black glass plates)

| | | | | | | | |
|---|---|---|---|---|---|---|---|
| transparency wet layer | 3 | 1 | 1 | 4 | 1 | 4 | 4 |
| transparency | 3 | 3 | 3 | 3 | 2 | 3 | 3 |
| cross-linked layer | | | | | | | |

Example 8 (long glass plates)

| | | | | | | | |
|---|---|---|---|---|---|---|---|
| Redispersibility dried layer | Yes | Yes | Yes | Yes | no | Yes | Yes |

Example 9 (veneered oak plates)

| | | | | | | | |
|---|---|---|---|---|---|---|---|
| water resistance cross- | 5 | 3.5 | 3.5 | 5 | 4 | 5 | 5 |
| linked layer, 1 h/0 h^{e)} | | | | | | | |
| water resistance cross- | 5 | 4.5 | 4.5 | 5 | 4 | 5 | 5 |
| linked layer, 1 h/24 h^{f)} | | | | | | | |
| water resistance cross- | 4 | 2.5 | 2.5 | 5 | 3 | 4 | 4 |
| linked layer, 16 h/0 h^{g)} | | | | | | | |
| water resistance cross- | 4 | 2.5 | 2.5 | 5 | 3 | 4 | 4 |
| linked layer, 16 h/24 h^{h)} | | | | | | | |

Example 10 (veneered oak plates)

| | | | | | | | |
|---|---|---|---|---|---|---|---|
| Anfeuerung, | 4.5 to 5.0 | 3.5 | 3.5 | 4.5 to 5.0 | 3.5 | 4.5 to 5.0 | 4.5 to 5.0 |
| cross-linked layer | | | | | | | |

^{a)}DB density PU = ethylenically unsaturated group density of the polyurethane [milliequivalents ethylenically unsaturated groups/g PU]
^{b)}DB (A1)/DB (PU) = equivalent ratio of ethylenically unsaturated groups of polyisocyanate (A1)/ethylenically unsaturated groups of components (B1), (B2), (B3) and (A1) and (C1)
^{c)} equivalent ratio of NCO groups of (A1) and (A2)/OH groups of (B1), (B2), (B3) and (B4)
^{d)}COOH density PU = COOH group and salt groups thereof density of the polyurethane
^{e)}water restance cross-linked layer, 1 h/0 h = water resistance of cross-linked layer after 1 h exposure to standing water, visual inspection immediately after removal of water exposure
^{f)}water restance cross-linked layer, 1 h/24 h = water resistance of cross-linked layer after 1 h exposure to standing water, visual inspection after 24 hours after removal of water exposure
^{g)}water restance cross-linked layer, 16 h/0 h = water resistance of cross-linked layer after 16 h exposure to standing water, visual inspection immediately after removal of water exposure
^{h)}water restance cross-linked layer, 16 h/24 h = water resistance of cross-linked layer after 16 h exposure to standing water, visual inspection after 24 hours after removal of water exposure

Table 1 shows that the wet layers formed from the coating compositions comprising the aqueous ethylenically unsaturated polyurethane compositions PUD1b, PUD1c and PUD1d, respectively, of the present invention on the black glass plate are clear and thus show a high transparency. The wet layer of the coating composition comprising the aqueous ethylenically unsaturated polyurethane composition PUD1a is milky immediately after being applied on a black glass plate. The wet layers of the comparative coating compositions comprising comparative aqueous ethylenically unsaturated polyurethane compositions cPUD1, cPUD 2 and cPUD3, respectively, however, are white immediately after being applied on a black glass plate.

Table 1 also shows that the cross-linked layer of the coating compositions comprising the aqueous ethylenically unsaturated polyurethane compositions PUD1a, PUD1b, PUD1c and PUD1d, respectively, of the present invention on black glass plates is clear and thus shows a high transparency. The cross-linked layer of the comparative coating compositions comprising comparative aqueous ethylenically unsaturated polyurethane compositions cPUD3 however is turbid and shows a bad transparency.

Table 1 also shows that the dried layers formed from the coating compositions comprising aqueous ethylenically unsaturated polyurethane compositions PUD1a, PUD1b, PUD1c and PUD1d, respectively, of the present invention on long glass plates are re-dispersible or re-soluble in water at ambient temperatures for a certain period. The dried layer formed from the comparative coating composition comprising comparative aqueous ethylenically unsaturated polyurethane composition cPUD3 on long glass plate, however, is not re-dispersible or re-soluble in water at ambient temperatures for a certain period.

Table 1 also shows that cross-linked layers formed from the coating compositions comprising the aqueous ethylenically unsaturated polyurethane compositions PUD1a, PUD1b, PUD1c and PUD1d, respectively, of the present invention on veneered oak plates show a high water resistance, whereas the cross-linked layers formed from comparative coating compositions comprising the comparative aqueous ethylenically unsaturated polyurethane compositions cPUD1, cPUD2 and cPUD3, respectively, on veneered oak plates show a much lower water resistance.

Table 1 also shows that the anfeuerung of veneered oak plates coated with cross-linked layers formed from the coating compositions comprising the aqueous ethylenically unsaturated polyurethane compositions PUD1a, PUD1b, PUD1c and PUD1d, respectively, of the present invention is better than the anfeuerung of veneered oak plates coated with cross-linked layers formed from the comparative coating compositions comprising comparative aqueous ethylenically unsaturated polyurethane compositions cPUD1, cPUD2 and cPUD3, respectively.

Thus, table 1 shows that coating compositions comprising the aqueous ethylenically unsaturated polyurethane compositions PUD1a, PUD1b, PUD1c and PUD1d, respectively, of the present invention show a favourable combination of high transparency of the wet layer good re-dispersibility or re-solubility of the dried layer and high water resistance and very good anfeuerung of the cross-linked layer on wood-based substrates, as well as good to and high transparency of the cross-linked layer.

### Example 11

### Preparation of an Aqueous Polyurethane Dispersion PUD1e Comprising Polyurethane Le

39.81 g 2,2-bis(hydroxymethyl) propionic acid, 144.04 g of a polytetrahydrofuran (MW 1000 g/mol), 87.81 g 2-hydroxyethyl acrylate, 0.8 g Kerobit®TBK (polymerization inhibitor), 0.08 g 2,2,6,6-tetramethylpiperidine-1-oxyl (polymerization inhibitor), 0.56 g Borchi®Kat 315 and 200 g butanone were mixed at 22° C. 507.75 g of the polyisocyanate A1a of example 1 was added, the temperature was increased to 80° C., and the reaction mixture was allowed to react until an NCO content of 0.65 weight % based on the weight of the reaction mixture was reached. The mixture was diluted with 370 g acetone, which leads to a drop in temperature of below 80° C. 18.95 g of a 50 weight % solution of N-aminoethyl-2-aminoethanesulfonic acid, sodium salt in water was added to the mixture and the reaction mixture was allowed to react for 10 min. 95.36 g of a 10 weight % solution of NaOH in water was added to the mixture and the reaction mixture was allowed to react for 5 min. 1150 g Water was added to the reaction mixture under rapid stirring. The organic solvents were removed by distillation to yield an aqueous composition PUD1e comprising polyurethane 1e having a solid content of 36.3 weight %, and the properties as shown in table 2.

TABLE 2

| | Aqueous polyurethane dispersion of ex 11 |
|---|---|
| PUD | PUD1e |
| (C1) | yes |
| DB density PU^{a)} | 2.34 |
| DB (A1)/DB(PU)^{b)} | 0.59/1.00 |
| NCO/OH^{c)} | 1.10/1.00 |
| COOH density PU^{d)} | 0.38 |
| Mn PU [g/mol] | 2486 |
| Mw PU [g/mol] | 9635 |

^{a)}DB density PU = ethylenically unsaturated group density of the polyurethane [milliequivalents ethylenically unsaturated groups/g PU]
^{b)}DB (A1)/DB (PU) = equivalent ratio of ethylenically unsaturated groups of polyisocyanate (A1)/ethylenically unsaturated groups of components (B1), (B2), (B3) and (A1) and (C1)
^{c)}equivalent ratio of NCO groups of (A1) and (A2)/OH groups of (B1), (B2), (B3) and (B4)
^{d)}COOH density PU = COOH group and salt groups thereof density of the polyurethane

1. A composition comprising
(i) at least one polyurethane (1) carrying ethylenically unsaturated groups and COOH groups,
wherein COOH groups are at least partly in the form of a salt group thereof,
wherein polyurethane (1) is obtainable-obtained by the reaction of
at least one polyol (B1) carrying at least one COOH group,
at least monoalcohol (B2) carrying at least one ethylenically unsaturated group,
optionally at least polyol (B3) carrying at least one ethylenically unsaturated group and no COOH group,
at least one polyol (B4) carrying no ethylenically unsaturated group and no COOH group,
at least one polyisocyanate (A1) carrying at least one ethylenically unsaturated group,
optionally at least one polyisocyanate (A2) carrying no ethylenically unsaturated group, and
optionally at least one compound (C1) carrying at least one NH2 group and no OH group,
wherein the equivalent ratio of ethylenically unsaturated groups of polyisocyanate (A1)/ethylenically unsaturated groups of components (B1), (B2), (B3), (A1) and (C1) is in a range of from 0.20/1.00 to 0.95/1.00, and
wherein the equivalent ratio of NCO groups of polyisocyanate (A1) and (A2)/OH groups of components (B1), (B2), (B3) and (B4) is in a range of from 1.00/1.00 to 1.50/1.00,
(ii) water, and
(iii) optionally at least one compound (2) carrying at least one ethylenically unsaturated group and no COOH group.

2. The composition of claim 1, wherein the equivalent ratio of ethylenically unsaturated groups of polyisocyanate (A1)/ethylenically unsaturated groups of components (B1), (B2), (B3), (A1) and (C1) is in a range of from 0.40/1.00 to 0.80/1.00.

3. The composition of claim 1, wherein the equivalent ratio of ethylenically unsaturated groups of polyisocyanate (A1)/ethylenically unsaturated groups of components (B1), (B2), (B3), (A1) and (C1) is in a range of from 0.50/1.00 to 0.70/1.00.

4. The composition of claim 1, wherein the ethylenically unsaturated groups are selected from the group consisting of acryloyl and methacryloyl groups.

5. The composition of claim 1, wherein polyol (B4) carrying no ethylenically unsaturated group and no COOH group is selected from the group consisting of polyester polyol carrying no ethylenically unsaturated group and no COOH group, polycarbonate polyol carrying no ethylenically unsaturated group and no COOH group and polyether polyol carrying no ethylenically unsaturated group and no COOH group.

6. The composition of claim 1, wherein polyisocyanate (A1) has an ethylenically unsaturated group density in a range of from 0.10 to 10.00 milliequivalents ethylenically unsaturated groups/g (A1) as determined by 1H-NMR.

7. The composition of claim 1, wherein polyisocyanate (A1) also comprises at least one allophanate group.

8. The composition of claim 1, wherein the polyurethane (1) has a weight average molecular weight Mw in a range of from 5000 g/mol to 30000 g/mol.

9. The composition of claim 1, wherein the salt of the COOH groups of polyurethane (1) is an alkali metal salt.

10. The composition of claim 1, wherein the ethylenically unsaturated group density of the polyurethane (1) is at least 1.00 milliequivalents of ethylenically unsaturated group/g of polyurethane (1).

11. The composition of claim 1, wherein the composition is a dispersion having an average particle size in a range of from 5 to 150 nm.

12. The composition of claim 1, wherein the composition comprises polyurethane (1) in a range of from 10 to 70% by weight based on the weight of the composition.

13. The composition of claim 1, wherein the polyurethane (1) is obtained by reacting
1 to 20% by weight of at least one polyol (B1) carrying at least one COOH group,
5 to 50% by weight of at least monoalcohol (B2) carrying at least one ethylenically unsaturated group,
0 to 30% by weight of at least polyol (B3) carrying at least one ethylenically unsaturated group and no COOH group,
5 to 60% by weight of at least one polyol (B4) carrying no ethylenically unsaturated group and no COOH group,
20 to 85% by weight of at least one polyisocyanate (A1) carrying at least one ethylenically unsaturated group,
0 to 40% by weight of at least one polyisocyanate (A2) carrying no ethylenically unsaturated group, and
0 to 15% by weight of at least one compound (C1) carrying at least one NH2 group and no OH group,
based on the sum of weights of (B1), (B2), (B3), (B4), (A1), (A2) and (C1).

14. An aqueous coating composition comprising the composition of claim 1, at least one additive, optionally at least one initiator and optionally at least one polymer (5) different from polyurethane (1), wherein the coating composition comprises polyurethane (1) in a range of from 10 to 70% by weight based on the weight of the coating composition.

15. A layer formed from the aqueous coating composition of claim 14.

16. A substrate coated with the layer of claim 15.

17. The substrate of claim 16, wherein the substrate is a wood substrate or an engineered wood substrate comprising veneer.

18. A method of using the coating composition of claim 1, the method comprising using the coating composition as a primer composition.

19. A method of using the coating composition claim 1, the method comprising using the coating composition as a pigmented wood stain composition.
